(19) United States
(12) Patent Application Publication
(10) Pub. No.: US 2025/0384864 A1
(43) Pub. Date: Dec. 18, 2025

(54) PANE-BASED ACOUSTIC SYSTEM

(71) Applicants: Zackery Belanger, Ann Arbor, MI (US); The Regents of the University of Michigan, Ann Arbor, MI (US)

(72) Inventors: Cathlyn Newell, Detroit, MI (US); Jonathan Wesley McGee, Ann Arbor, MI (US); Zackery Belanger, Detroit, MI (US)

(21) Appl. No.: 18/877,802

(22) PCT Filed: Jun. 21, 2023
(86) PCT No.: PCT/US2023/025874

§ 371 Date: Dec. 20, 2024

Related U.S. Application Data
(60) Provisional application No. 63/354,183, filed on Jun. 21, 2022.

(51) Int. Cl. G10K 11/162; G10K 11/18

(52) U.S. Cl. CPC G10K 11/162; G10K 11/18

(57) ABSTRACT

An acoustic system includes a framework and a plurality of panes supported by the framework and arranged to form an acoustic surface. Each pane of the plurality of panes includes a face with a respective degree of curvature, the face having a respective number of holes, the number being zero or more. The degree of curvature and the number of holes differ across the plurality of panes to establish a monotonic gradient in an acoustic function across an extent of the acoustic surface.

### CROSS-REFERENCE TO RELATED APPLICATION

This application claims the benefit of U.S. provisional application entitled “Pane-Based Acoustic System,” filed Jun. 21, 2022, and assigned Ser. No. 63/354,183, the entire disclosure of which is hereby expressly incorporated by reference.

### BACKGROUND OF THE DISCLOSURE

### Field of the Disclosure

The disclosure generally relates to acoustic devices and systems.

### Brief Description of Related Technology

Building interiors are predominately flat and orthogonal. These attributes preserve sonic content in the form of sustained reverberation and repetitive sound propagation paths. Such spaces are thus often acoustically harsh, and poor for concentration and communication.

As an architectural material, glass offers unique attributes of crisp visual transparency, durability, strength, and malleability at a wide range of scales. While glass has typically remained flat in architectural contexts, glass has often been bent via molds. Glass sheets mounted on molds are conveyed through a lehr having zones of progressively increasing temperature. Eventually the glass sheet is allowed to settle freely onto the surface of the mold. When the mold surface includes portions of sharp curvature, local zones of concentrated heat have been used to create rapid softening of the corresponding areas of the glass. Such localized heating have been provided via placement of gas burners or electrical heating elements. Reflectors and heat shields have also been used in efforts to selectively apply heat. Nevertheless, these techniques unfortunately result in undesired heating of other portions.

Use of molds is also often prohibitively expensive. For instance, molds capable of withstanding the elevated temperatures of glass forming are expensive and time consuming to produce. Moreover, any system having variation in component shapes involves the creation of a separate mold for each respective shape. The creation of each separate mold accordingly increases the cost of fabrication.

### SUMMARY OF THE DISCLOSURE

In accordance with one aspect of the disclosure, an acoustic system includes a framework, and a plurality of panes supported by the framework and arranged to form an acoustic surface. Each pane of the plurality of panes includes a face with a respective degree of curvature, the face having a respective number of holes, the number being zero or more. The degree of curvature and the number of holes differ across the plurality of panes to establish a monotonic gradient in an acoustic function across an extent of the acoustic surface.

In connection with any one of the aforementioned aspects, the systems described herein may alternatively or additionally include or involve any combination of one or more of the following aspects or features. The acoustic function is dissipation. The acoustic function is absorption. The acoustic function is reflection. The acoustic function is transmission. The acoustic function is diffusion. The acoustic surface has a first end and a second end. The monotonic gradient extends from the first end to the second end. The degree of curvature and the number of holes of the plurality of panes establishes a plurality of zones of the acoustic surface. The panes in each zone of the plurality of zones collectively establish a primary acoustic function for the zone. The primary acoustic functions differ across the plurality of zones. The panes in each zone of the plurality of zones are configured such that an acoustic response of each zone includes further acoustic functions at a lower level than the primary acoustic function. The primary acoustic function of a first zone of the plurality of zones is reflection. The primary acoustic function of a second zone of the plurality of zones is diffusion. The primary acoustic function of a third zone of the plurality of zones is absorption. The first, second, and third zones are disposed in a sequential arrangement across the extent of the acoustic surface in accordance with the monotonic gradient. The plurality of zones include a fourth zone in which transmission is the primary acoustic function. The fourth zone is adjacent the third zone. The panes in the first zone are flat and have zero holes. The curvature of the faces of the panes increases along the gradient. The number of holes in the faces of the panes increases along the gradient. The holes in the face of each pane of the plurality of panes have respective sizes that decrease as distance from a centroid of the pane increases.

### BRIEF DESCRIPTION OF THE DRAWING FIGURES

FIG. 1 is a flow diagram of a method of fabricating an acoustic device in accordance with one example.

FIG. 2 is an elevational view of an acoustic system that includes a plurality of acoustic devices in accordance with one example.

FIG. 3 is a schematic view of a flat panel having a cut pattern prior to thermoforming in accordance with one example.

FIG. 4 is a perspective view of an acoustic device having auxetic features as a result of thermoforming in accordance with one example.

FIG. 5 is a schematic view of a flat panel having a cut pattern prior to thermoforming in accordance with one example.

FIG. 6 is a schematic view of an acoustic device as a result of thermoforming in accordance with one example.

FIG. 7 depicts schematic views of a number of flat panels having various cut patterns in accordance with several examples.

FIG. 8 is a schematic view of a flat panel having an asymmetrical cut pattern that varies across a surface of the flat panel in accordance with one example.

FIG. 9 depicts perspective views of a number of acoustic devices having various cut patterns in accordance with several examples.

FIG. 10 is an elevational view of an acoustic system having an arrangement of panes in accordance with one example.

FIG. 11 is a view of a support frame for use in the fabrication method of FIG. 1 in accordance with one example.

FIG. 12 is a schematic view of a flat panel having features configured for engagement by a support frame in accordance with one example.

FIG. 13 is a schematic view of a flat panel in connection with support rods used in the fabrication method of FIG. 1 in accordance with one example.

FIG. 14 depicts perspective views of a number of acoustic devices having various perimeter shapes in accordance with several examples.

FIG. 15 is a schematic view of a suspension system of an acoustic system in accordance with one example.

FIG. 16 is a perspective view of a curved pane having auxetic features in accordance with one example.

FIG. 17 is an elevational view of an acoustic system having an arrangement of panes in accordance with one example.

FIG. 18 is a perspective view of an acoustic system having a multi-layer arrangement of panes in accordance with one example.

FIG. 19 depicts schematic views of a number of flat panels having various cut patterns prior to thermoforming in accordance with several examples.

FIG. 20 depicts schematic and perspective views of an acoustic device having a uniform cut pattern before thermoforming and non-auxetic features after thermoforming in accordance with one example.

FIG. 21 is schematic view of a flat panel having a cut pattern in accordance with one example.

FIG. 22 depicts schematic and perspective views of an acoustic device having a variable cut pattern before thermoforming and auxetic features after thermoforming in accordance with one example.

FIG. 23 is a perspective view of an acoustic system having a number of panes arranged across multiple surfaces in accordance with one example.

FIG. 24 depicts schematic, side views of multiple layer arrangements of acoustic panes in accordance with several examples.

FIG. 25 is a schematic view of an acoustic system having a plurality of panes arranged and otherwise configured to provide multiple acoustic functions in accordance with one example.

FIG. 26 is a schematic view of an acoustic system having a plurality of panes in which perforation patterns are shared by, or extend across, adjacent panes in accordance with one example.

FIG. 27 is an elevational, schematic view of an acoustic system having a plurality of panes with holes configured to exhibit a gradient in an acoustic function in accordance with one example.

FIG. 28 are elevational, side views of panes disposed in a multiple layer arrangement in accordance with one example.

FIG. 29 is an elevational, schematic view of an acoustic system having a plurality of panes disposed in two layers and configured to exhibit a gradient in an acoustic function in accordance with one example.

FIG. 30 is an elevational view of pane pairs disposed back-to-back to define interior spaces in accordance with two examples.

FIG. 31 depicts images generated via a simulation of an acoustic system configured to exhibit a gradient in an acoustic function in accordance with one example.

FIG. 32 depicts schematic views of gradients in acoustic functions exhibited by an acoustic system in accordance with one example.

FIG. 33 is an elevational view of an acoustic system configured to exhibit a gradient in an acoustic function in accordance with one example.

FIG. 34 is a graphical plot of absorption as a function of frequency for a number of sections of the acoustic system of FIG. 33.

The embodiments of the disclosed systems and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

The disclosure relates to thermoformed acoustic devices and systems. The disclosed devices and systems may be used to implement a wide variety of surface shaping solutions to manipulate sonic character. The solutions may accordingly be directed to achieving desired interior acoustic performance, including, for instance, performance that balances comfort and function. Methods of fabricating the acoustic devices are also described. The acoustic devices are configured as curved panels. The panels are fabricated via thermoforming techniques that do not rely on molds to achieve desired curvature(s). The thermoforming techniques instead involve controllably allowing the panels to slump or sag. The deformation from such sagging or slumping may result in a variety of curvatures. Control of the deformation is provided via a plurality of cuts in the panel, as well as other parameters, such as temperature, perimeter shape, and panel thickness. As described below, the cuts may be configured to provide auxetic features in the acoustic device. The cuts may be arranged in various patterns to achieve different curvatures and, thus, acoustic effects. The disclosed acoustic systems include various arrangements of the acoustic devices.

The disclosed devices and systems may use the selective removal of material from the panels to achieve various acoustic effects, e.g., reflection, diffusion, filtering, focusing, dissipation, transparency, etc., and combinations thereof. For instance, the amount of curvature may be determinative of an extent of diffusive behavior. The disclosed fabrication methods allow a wide variety of shapes and, thus, acoustic effects, to be achieved. The aggregation of similar or differing devices into various arrangements provides additional acoustic configurability.

The disclosed methods, devices, and systems may use glass plates or sheets. Plate glass, the form of which has controllable and uniform acoustic behavior, may be formed into curved surfaces through a combination of parametrically-driven auxetic pattern generation, CNC water-jet cutting, and controlled heat forming. The plate glass may be curved to achieve complex acoustic behavior. The cut pattern allows the curvature to be altered and controlled across the pane of glass. Additional or alternative parameters of the thermoforming procedure may be used to control the curvature, as described below.

The disclosed acoustic devices and systems may be used in a wide variety of applications. For instance, the devices and systems may be mounted on walls, suspended (e.g., from a set of wires) and/or attached to a ceiling (or other mounting surface), or otherwise disposed to absorb, dissipate, or otherwise affect noise and/or other sound. Alternatively, the devices and systems may be disposed in a standalone configuration (e.g., a free-standing arrangement), or constitute a wall, ceiling, or other architectural or structural element itself. The devices and systems may thus constitute or provide an enclosure rather than be applied to one. In some cases, the devices and systems may be configured and used to correct or otherwise address the acoustics of a room or other space. For instance, various types of echo or resonance effects may be augmented or diminished.

The disclosed methods are directed to fabricating an acoustic pane or other device with both curvature and perforation or other holes or openings. Both of these aspects have useful acoustic effects. Curved glass may be used to achieve a distinct diffusion effect. The perforations may be used to allow passage of sound (e.g., past the pane) to an absorber or to achieve a Helmholtz or trapping effect. The ability to control the shape of the curved acoustic device without the use of a mold is also useful.

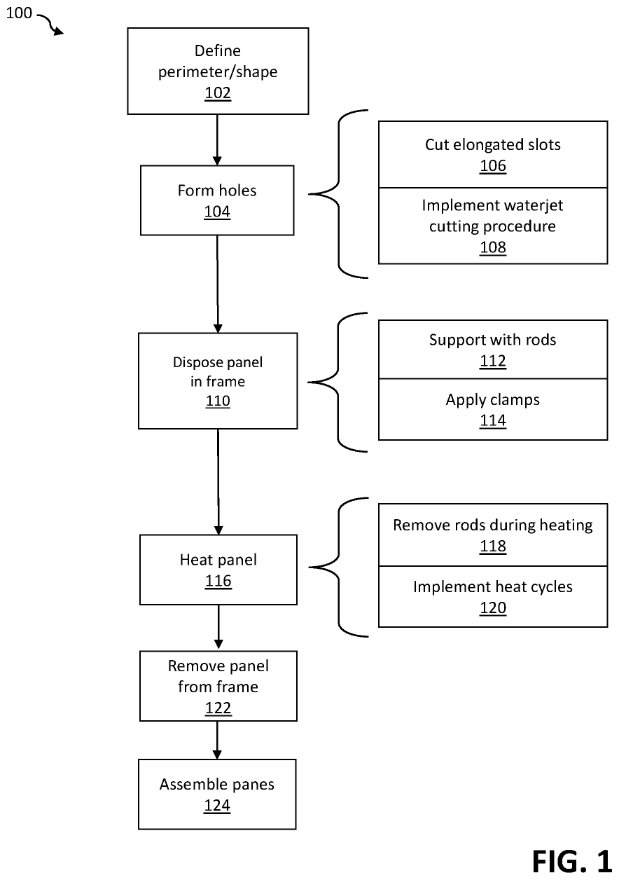

FIG. 1 depicts a method 100 of fabricating an acoustic device, such as a pane. The method 100 may include an act 102 in which a flat panel is cut to define a perimeter or shape of the flat panel. The perimeter of the flat panel may be cut to accommodate (e.g., match) the shape of a support frame (described below) and/or achieve a desired shape suitable for an application. The shape may thus vary to accommodate an arrangement of acoustic devices and/or the shape of the wall or other surface on which the acoustic devices are deployed or otherwise arranged. Alternatively or additionally, the shape may vary to create or establish a partition, ceiling, wall, or other surface or structure. A wide variety of shapes may be used, including, for instance, rectilinear shapes such as a square, hexagon, or triangle, and non-rectilinear shapes. As described herein, the pane may be disposed in an array, set, grouping, or other plurality of panes in various arrangements or configurations (e.g., tiled, layered, overlapping, etc.) to form an acoustic system.

The panel may or may not be flat or planar at this point. In some cases, the panel may be curved to any desired extent. Such curvature may, for instance, be an artifact of the panel formation procedure.

In some cases, the flat panel may be composed of, or otherwise include, a glass material. For example, the glass material may be or include plate glass, but any glass material may be used. Use of glass may be useful for multiple reasons, including, for instance, the flame resistance of glass. Nonetheless, alternative or additional materials may be used, including, for instance, plastic materials. The panel may be composed of, or otherwise include, yet further material or materials.

The method 100 includes an act 104 in which a number of holes are formed in the panel. In some cases, forming the holes includes an act 106 in which a number of slots are cut into the panel. Some or all of the holes may thus be configured as slits or slots, or are otherwise elongated. Alternatively or additionally, some or all of the holes are non-straight. For example, the holes may be V-shaped. The shape of the holes may otherwise vary, e.g., across the surface of the panel, or between panels. The number, spacing, relative orientation, width, and/or other characteristics of the holes may also vary.

The holes may be formed in the panel using various material removal techniques, including mechanical, chemical, irradiation, and other procedures. In some cases, the act 104 includes implementation of a waterjet cutting procedure in an act 108. The resulting holes in the float glass may thus be the width of the kerf of the waterjet. In some cases, the kerf of the water jet is such that the holes have a width that falls in a range from about 0.034 inches to about 0.044 inches. In other cases, holes of other widths may be formed, e.g., with a waterjet having a kerf that falls in a range from about 0.01 inches to about 0.1 inches. The waterjet cutting procedure may be a computer numerical controlled (CNC) procedure. Alternative or additional procedures may be used. For instance, the material removal may include various types of cutting procedures, such as laser ablation.

The plurality of holes may be distributed or positioned across the panel in accordance with a pattern. The pattern may be symmetrical or asymmetrical. A number of example patterns are shown and described herein.

The method includes an act 110 in which the panel is loaded or otherwise disposed into a support frame. The support frame is configured to support the panel during heating. For instance, the support frame may be sized and include components suitable for disposition within a kiln or other heating apparatus. Further details regarding examples of support frames are described and shown herein.

The support frame may be configured to allow the panel to slump or sag during the heating process. For instance, the support frame may be configured to engage the panel at one or more points along the perimeter of the panel. One or more characteristics of the panel may be accordingly configured to engage the support frame, as described herein. The perimeter of the panel may thus be held stationary while an interior of the panel deforms under its own weight.

In some cases, the act 110 includes an act 112, in which the flat panel is supported with a plurality of rods. The rods provide initial or temporary support of the interior of the panel. For instance, the rods may be used as the flat panel is initially heated. Such temporary support helps to prevent the glass from breaking before it reaches full slump temperature. The rods are then removed at a suitable time in the heating sequence. The rods may be positioned across the lateral extent of the panel.

Other components may be used to support the panel during implementation of the method 100. For example, the support frame may include or otherwise support the use of a number of clamps. The act 110 may thus include an act 114, in which the clamps are applied to the perimeter of the panel to secure the panel to the support frame.

The method 100 includes an act 116 in which the panel is heated. The panel may be disposed in a kiln or other apparatus. The heating raises the panel to a temperature such that the panel deforms while disposed in the support frame. The deformation includes slumping or sagging of the panel. The holes in the panel may be used to control the extent of the slump or sag. For instance, the panel may sag more in areas in which the density of holes is greater.

The thermal deformation may also include or involve the modification of one or more of the holes in the panel. In some cases, the modification may include auxetic deformation. For example, the panel (e.g., a portion of the panel) may twist or otherwise deform in addition to the general curvature of the slump or sagging. In some cases, the auxetic behavior includes the modification of the shape of the holes. For instance, a slot may become diamond shaped. Alternatively or additionally, some or all of the deformation may be non-auxetic.

In some cases, the act 116 includes removal of the support rods in an act 118. The rods may be removed after the temperature of the kiln reaches a level at which the panel is no longer at risk of thermal shock. The removal temperature may vary with various other parameters, including, for instance, the thickness and/or composition of the panel.

The kiln may implement a heating sequence in an act 120. The sequence may include a number of cycles or other stages, examples of which are described below. Each stage may be defined by a number of parameters, including an initial temperature, a final temperature, a temperature gradient, and a time period. The sequence may vary from merely ramping up from an initial temperature (e.g., room temperature) and back down. For instance, the sequence may include one or more stages in which the temperature is lowered for a period of time.

The support frame may be tightened at a temperature of 1076 F/580 C. The support rods may be removed, allowing the glass to sag freely. Glass may be permitted to sag from, for instance, 0″-10″ of depth. The amount of sagging may vary as a result of one or more parameters of the fabrication process, the dimensions of the panel, etc. Various heating cycles may be implemented. The depth of the curvature may be controlled by the duration of time of the kiln heating cycle. One or more slumps may be formed on the flat panel to create a curved panel. The extent of the deformation of the curved panel depends on the configuration of the geometric shapes, the thickness of sheet panel, the perimeter of the sheet panel, the placement of the heat, and the time the heat is applied. Once the heating cycle is complete, the glass is removed. In an embodiment, the glass panel is assembled on wires held in tension using hardware attachments.

The method 100 may include an act 122 in which the panel is removed from the support frame. In some cases, the panel may then be aggregated with other panels for assembly into an acoustic system in an act 124. The assembly may include installation of the panels into a support framework, examples of which are described below.

The method 100 may include fewer, additional, or alternative acts. For instance, the panels may be pre-cut into a desired shape.

The order in which the acts of the method 100 are implemented may vary from the example shown in FIG. 1. For instance, the holes may be formed before the panels are cut into a desired shape.

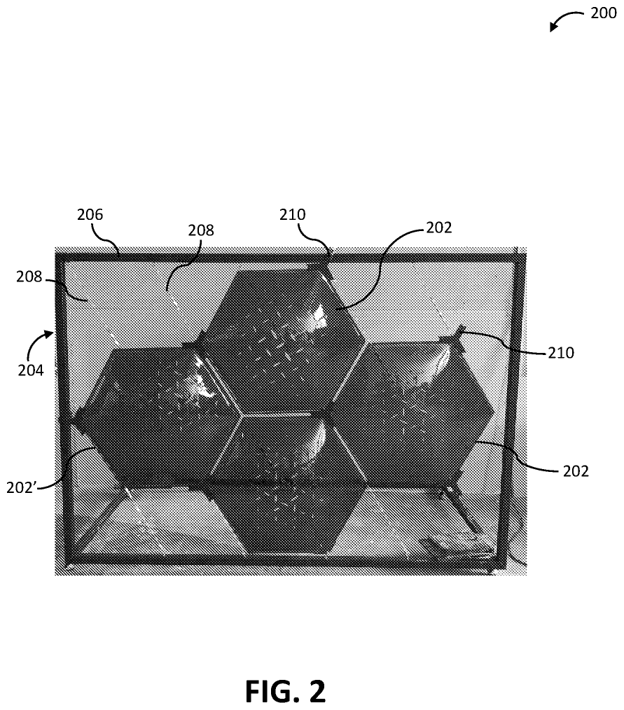

FIG. 2 depicts an acoustic system 200 that includes an arrangement of acoustic panes 202. Each acoustic pane 202 may be or include an acoustic device fabricated in accordance with the method 100 of FIG. 1. The acoustic panes 202 may be arranged and otherwise configured so that the acoustic system 200 achieves a desired acoustic effect and/or performs a desired acoustic function. For instance, the panes 202 may be configured such that the acoustic system 200 provides a diffusive effect or acts as a sound absorber or a resonator. Alternative or additional effects or functions may be provided.

Fewer, additional, or alternative panes 202 may be included in the acoustic system 200. For instance, the number of panes 202 may be limited for purposes of ease in illustration or description. In some cases, the acoustic system 200 may instead include a number of panes sufficient to cover most, if not all, of a wall of a room. In other cases, the acoustic system 200 constitutes the wall, ceiling, or other structural component of the room itself, or, in still other cases, the entire room or other enclosure.

Each acoustic pane 202 of the acoustic system 200 may or may not be similarly configured. In the example of FIG. 2, each acoustic pane 202 has a hexagonal shape. However, the pattern or distribution of holes may in each acoustic pane 202 may differ. For instance, the pane 202′ has a non-uniform or asymmetrical hole distribution that differs from the other acoustic panes 202. In this case, the hole distribution of the pane 202′ is skewed toward one side. In contrast, the other acoustic panes 202 may have a symmetrical and centered distribution of holes. The panes of the acoustic system 200 may vary relative to one another in one or more other ways, including, for instance, shape, surface area, thickness, and material composition.

The acoustic system includes a framework 204 to support the acoustic panes 202. In this example, the framework 204 includes an outer frame 206 and a set of wires 208 secured to, and extending between, sides of the outer frame 206. The acoustic panes 202 are disposed and mounted within the framework 204 using the wires 208 as guides. In some cases, the wires 208 are held in tension. The wires 208 may thus take the weight of each pane 202 so that each pane 202 is suspended and not bearing the weight of any neighboring panes 202. In this example, the wires 208 are secured to the acoustic panes 202 using attachment clips 210. The manner in which the acoustic panes 202 are assembled into the framework 204 may vary. For instance, alternative or additional types of attachment hardware may be used, such as various types of snaps or hooks.

Each acoustic pane 202 has a perimeter and an interior face within the perimeter. In this example, the perimeter is configured such that each acoustic pane 202 has a hexagonal shape. The hexagonal shape may be useful for minimizing space between adjacent acoustic panes 202. Alternative or additional shapes may be used. For instance, the system 200 may include one or more acoustic panes shaped to fill a non-hexagonal space adjacent to the outer frame 206.

The interior face of each acoustic pane 202 is curved. The curvature may be the result of the above-described thermoforming procedure. In this example, each acoustic pane 202 is oriented to present a convex curvature. The convex curvature may be useful for providing, e.g., a diffusive acoustic effect. Concave or other (e.g., more complex) curvatures may alternatively or additionally be included. The curvature may vary within each acoustic pane 202 and/or between different acoustic panes 202. For instance, the curvature may vary such that the interior face is flat, minimally slumped, moderately slumped, and/or deeply slumped. The amount of curvature may be tailored to achieve a desired amount of diffusion and/or any other acoustic effect or function. The curvature (depth) and other dimensions of the acoustic panes 202 may be selected such that the acoustic panes 202 exhibit dimensions of at least one-quarter of the largest wavelength (lowest frequency) to be diffused. The aggregation of the acoustic panels 202 into the acoustic system 200 provides for additional diffusion.

The interior face of each acoustic pane 202 has a plurality of holes. In this example, each hole is elongated. The orientation of the holes 202 may vary. In this case, the holes of one of the acoustic panes 202 are oriented orthogonally to one another. The holes of the other acoustic panes 202 are oriented at other angles.

The lateral distribution of the holes in each acoustic pane 202 may also vary. In this example, the holes are not located near the perimeter of the acoustic pane 202. For instance, the holes are spaced from the perimeter more than the spacing between adjacent holes.

The acoustic panes 202 in the example of FIG. 2 may have non-auxetic features or surfaces. In other cases, one or more of the acoustic panes 202 instead has an interior face twisted beyond the curvature of the acoustic pane 202. Such twisting may be located at one or more of the holes. Other types of auxetic features may be included, as described below.

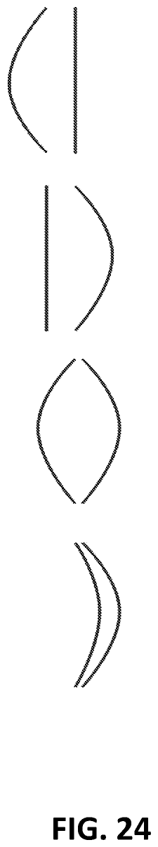

In the example of FIG. 2, the acoustic system 100 includes a single layer of acoustic panes. In other cases, the arrangement may include multiple layers. For instance, the arrangement may include multiple (e.g., two) layers with acoustic panes disposed in a front-to-back, back-to-back, or other arrangement. Various examples of two-layer arrangements are shown in FIG. 24. The panes in the multiple layers may or may not be aligned as shown in the examples of FIG. 24. Thus, the panes in adjacent layers may be offset from one another. In some cases, the holes in the pane of one layer may be aligned with the holes in the adjacent layer. In other cases, the holes in the panes of the adjacent layers are not aligned. In still other cases, one of panes has holes, while the other pane does not have holes. The spacing or volume between adjacent layers may be varied or otherwise selected to tailor or achieve a desired acoustic effect. The number of layers in multiple layer arrangements may exceed two layers in other cases.

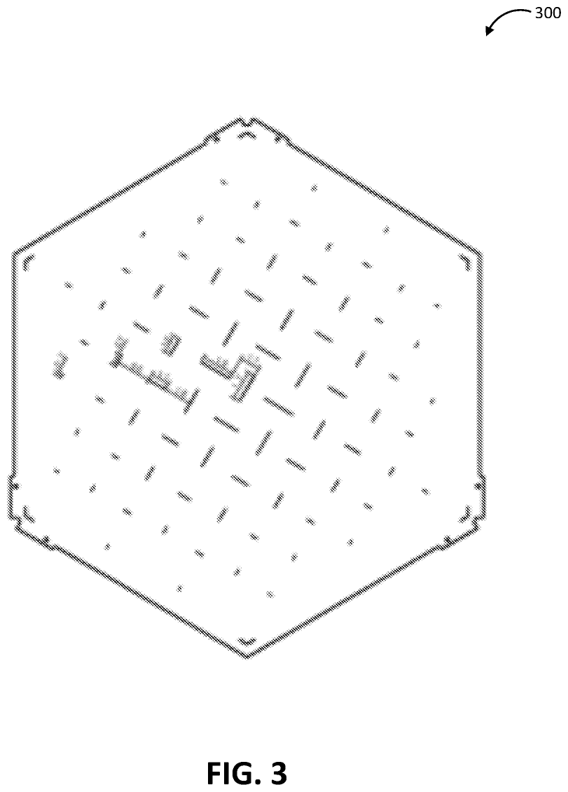

FIG. 3 depicts a panel having a cut pattern in accordance with one example. In this case, the panel is flat. The panel may be processed in accordance with the method 100 of FIG. 1, or another method, to form one of the acoustic panes 202 of the acoustic system 200 of FIG. 2, or another acoustic device or system.

The flat panel is composed of a material capable of deformation when the material is exposed to heat. For example, the flat panel may be composed of, or otherwise include, a glass or plastic material. In some cases, the glass material may be or include float glass (e.g., 4 mm float glass). Float glass may be useful because it has uniform thickness and may produce sheets with flat surfaces. Float glass has a high structural flexibility and is capable of being easily shaped and bent into a variety of forms while it is in a heated state. The flat panel may be pre-cut to specific geometrical shapes, as described above.

The panel includes a plurality of elongated holes arranged in a pattern. In this example, the pattern includes holes oriented in one of two directions. The directions are orthogonal to one another. The holes alternate between the two orientations. In this case, the size (e.g., length) of the holes varies, with the longest holes at or near the center of the panel, and the shortest holes being closest to the perimeter of the panel. Such variance in hole size, and corresponding hole-to-hole spacing, may be useful for varying the extent of the slump or sag during thermoforming. In this case, the panel sags the most in the center and the least near the perimeter. Other hole patterns, sizes, orientations, and distributions may be used. The holes may vary in additional or alternative ways. For instance, the width or shape of the holes may vary.

The patterning may be used to determine whether the panel exhibits auxetic behavior during slumping. Some patterns lead to panels slumping in accordance with a positive Poisson's ratio. In such cases, the panel deforms in the direction in which the panel is stretched. Other patterns lead to panels exhibiting auxetic behavior, or a negative Poisson's ratio, in which deformation occurs in directions other than the stretching force. The panel may thus include features that twist out of the general curvature of the slump.

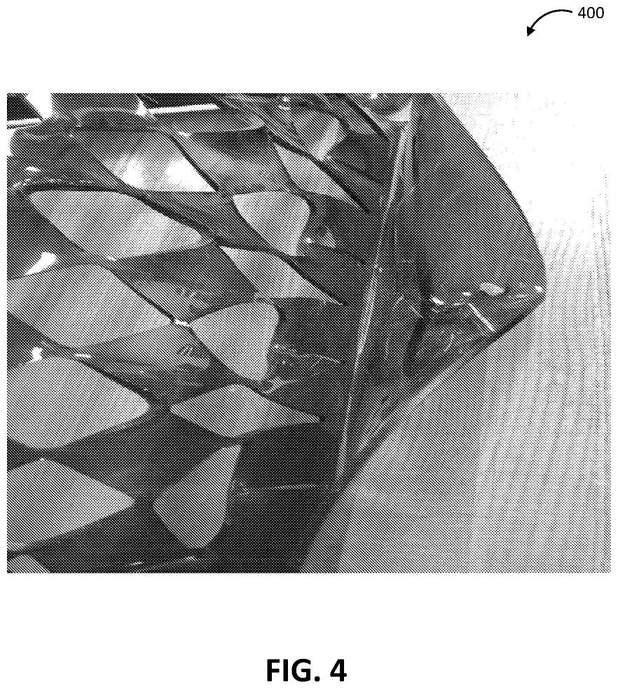

FIG. 4 depicts an example of a panel having a cut pattern that leads to auxetic deformation. The cuts in the panel are configured such that the surface twists or spins during slumping. The interior face is thus twisted beyond the curvature at one or more of the holes. The cuts are also configured such that the size of the opening increases as the panel slumps. The spacing and length of the cuts may be selected to support such deformation.

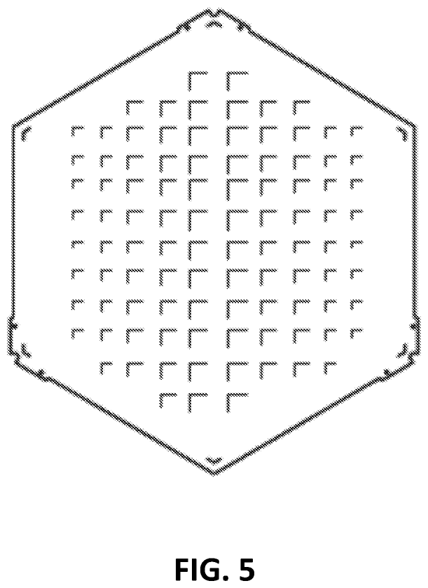

FIG. 5 depicts a panel having a cut pattern in accordance with another example. The panel may be processed in accordance with the method 100 of FIG. 1, or another method, to form one of the acoustic panes 202 of the acoustic system 200 of FIG. 2, or another acoustic device or system. The panel may have a composition and other characteristics similar to the examples described above. For instance, the panel also includes a plurality of holes arranged in a pattern. As in other examples, the pattern is an array with the holes arranged in a number rows and columns. In this example, however, the holes are not elongated cuts. The holes are instead non-straight. In this case, each hole includes a V-shaped cut.

The size of the cuts varies across the surface of the panel. In this example, larger cuts are located in the columns located along a center axis. The cuts in other columns become smaller as the lateral distance from the center axis increases.

When the panel is heating to slumping temperatures, the V-shaped cuts may or may not exhibit auxetic behavior depending on various parameters, including, for instance, the length of the cuts, the spacing of the cuts, and the temperature sequence. The V-shaped cuts may be used to create directional flaps. Other cuts may alternatively or additionally be used to create directional flaps.

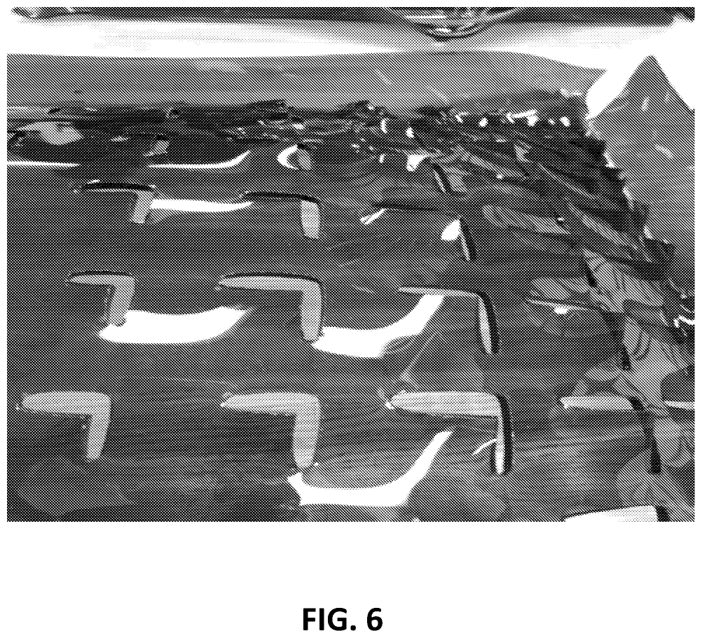

FIG. 6 depicts an example of a panel having V-shaped cuts after heating to a slumping temperature. In this case, the slumping results in non-auxetic expansion of the V-shaped cuts. In other cases, the cuts may exhibit auxetic behavior. For instance, the panel may develop flaps at each cut that sag beyond the curvature of the panel.

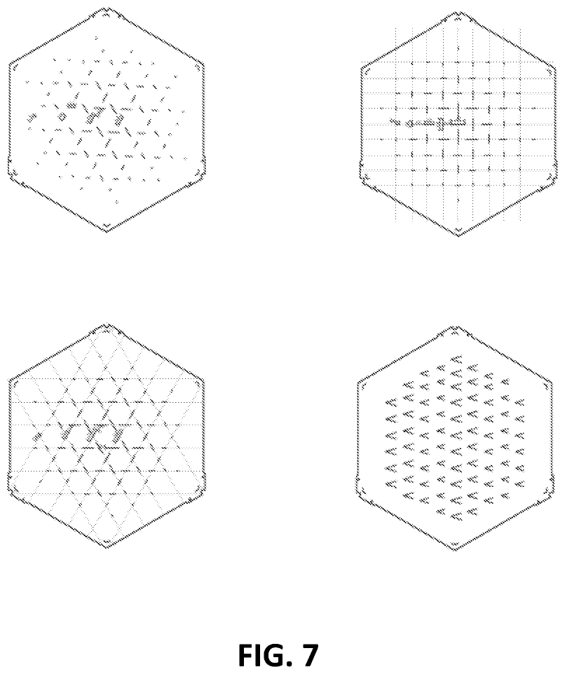

FIG. 7 depicts several examples of panels with other cut patterns. The examples depict how the orientation, length (or other size), directionality, and spacing of the cuts may vary. The examples also depict how the cuts may vary across the surface of a panel. Still other cut patterns may be used. For instance, a panel may have a combination of non-straight (e.g., V-shaped) and straight cuts.

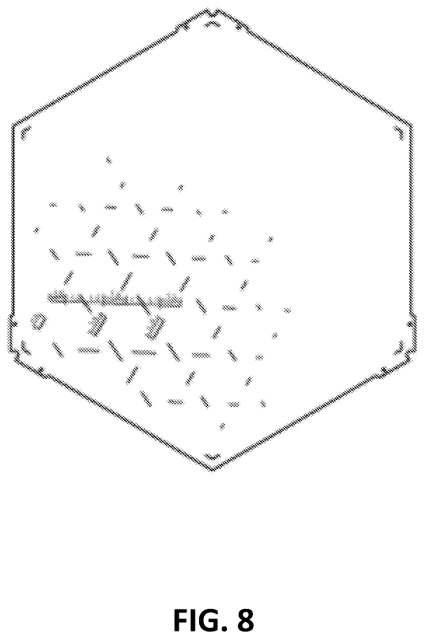

FIG. 8 depicts an example of a panel with holes in a radially asymmetric arrangement. In this example, the holes are biased toward one side of the hexagonal shape of the panel. The asymmetry may be useful for controlling the magnitude or extent of certain acoustic effects. For instance, the holes may be used to increase absorption for sound that would otherwise be reflected in one direction, while the absence of holes may be used to allow a relatively greater amount of sound to be reflected in another direction.

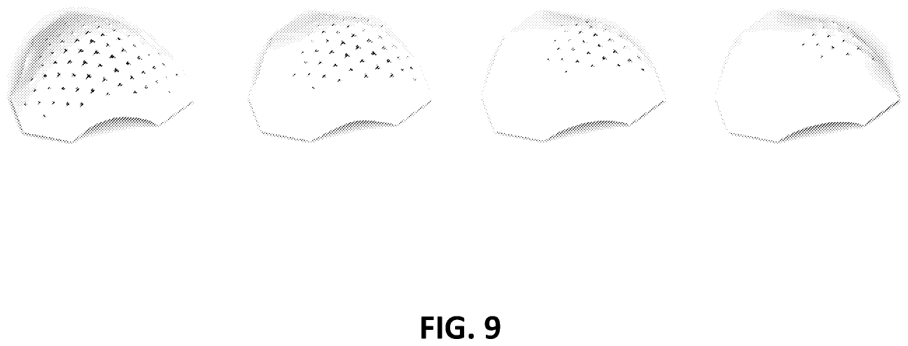

FIG. 9 depicts a set of acoustic devices that may be aggregated in a system to achieve a desired acoustic effect. In this example, the acoustic devices have different hole patterns. The hole patterns vary in the extent of distribution across the surface of the pane. The acoustic devices may be arranged along a wall or other surface to control the amount of absorption and reflection at various positions. For example, the acoustic devices with a greater, symmetrical distribution of holes may be disposed in the center of the wall (for relatively higher absorption in the center), while other acoustic devices with decreasing hole distributions are used as the distance from the center of the wall increases. Other arrangements may be used. For instance, the acoustic devices may be arranged in the opposite manner, i.e., with acoustic devices having more holes away from the center of the wall.

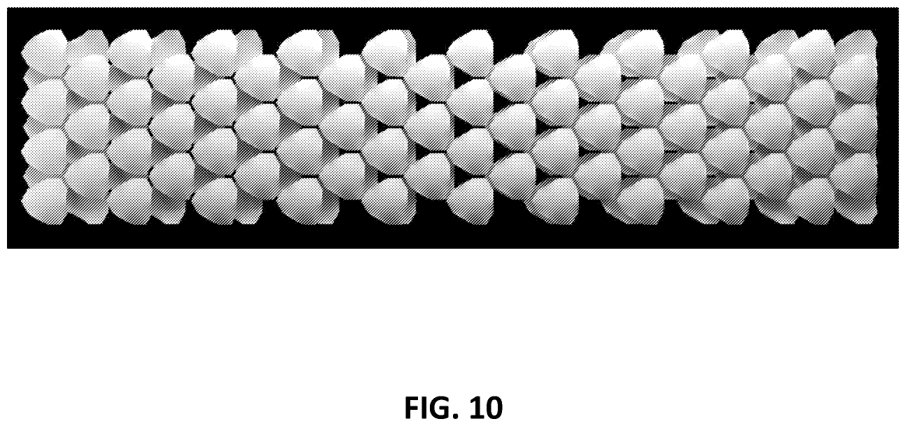

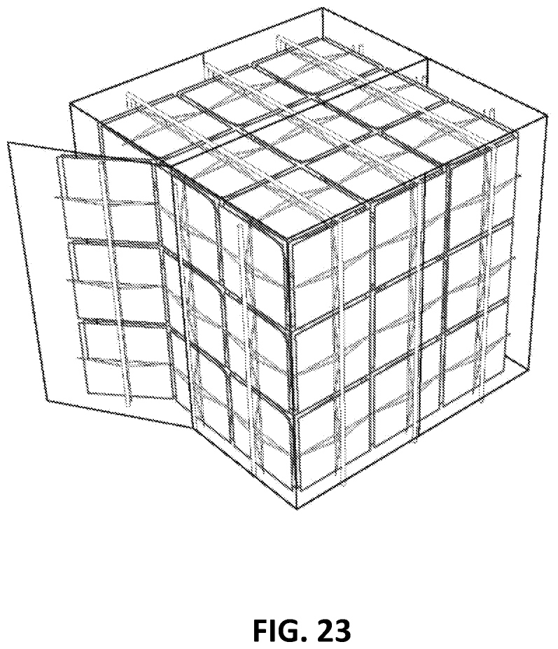

FIG. 10 depicts an acoustic system having multiple layers of panes. In some cases, the acoustic system is mounted on a wall. Other types of backers, substrates, or mounting surfaces may be used, including, for instance, a sheet of flat glass (e.g., a sheet without holes), an example of which is shown in FIG. 23. In still other cases, the acoustic system is free standing (e.g., in a standalone configuration), or suspended from ceiling or other object. In this example, the acoustic system includes two layers of panes. The panes of the two layers may be oriented back to back, such that the panes in the front layer are convex relative to the incident sound, and the panes in the rear layer are concave. Other orientations may be used. The panes of the two layers may be laterally offset from one another as shown. The degree of overlap may vary across the acoustic system, such that panes near the lateral edges may be less offset, if at all. The panes may be aligned or offset to any desired extent.

In some cases, a two or other multiple layer system may be used to create an enclosure volume. The panels of the multiple layers may be aligned in such cases. One or more interfaces may be sealed to facilitate enclosure. Such systems may be useful in providing, for instance, absorption due to Helmholtz resonance.

Each pane may be configured in accordance with any one of the examples of acoustic devices described herein, or another acoustic device. In this example, each pane has an asymmetrical perimeter shape. Each pane may have any hole pattern. The holes are not depicted in FIG. 10 for ease in illustration.

The acoustic function of the acoustic system may vary in accordance with the positioning and offset of the panes of the two layers, as well as the hole distributions within each pane. By changing these parameters, the acoustic system (or a respective portion thereof) may perform as a focuser, reflector, diffuser, dissipator, or even as an absorber. The acoustic functionality of the acoustic system may be frequency dependent.

The acoustic function of the system (or system portion) may be established by a grouping of panes. In some cases, the acoustic system may include multiple groupings. Thus, the configuration and arrangement of the panes may establish different functions for respective sections, zones or other portions of the acoustic system. The panes in each portion may collectively establish the function of the portion.

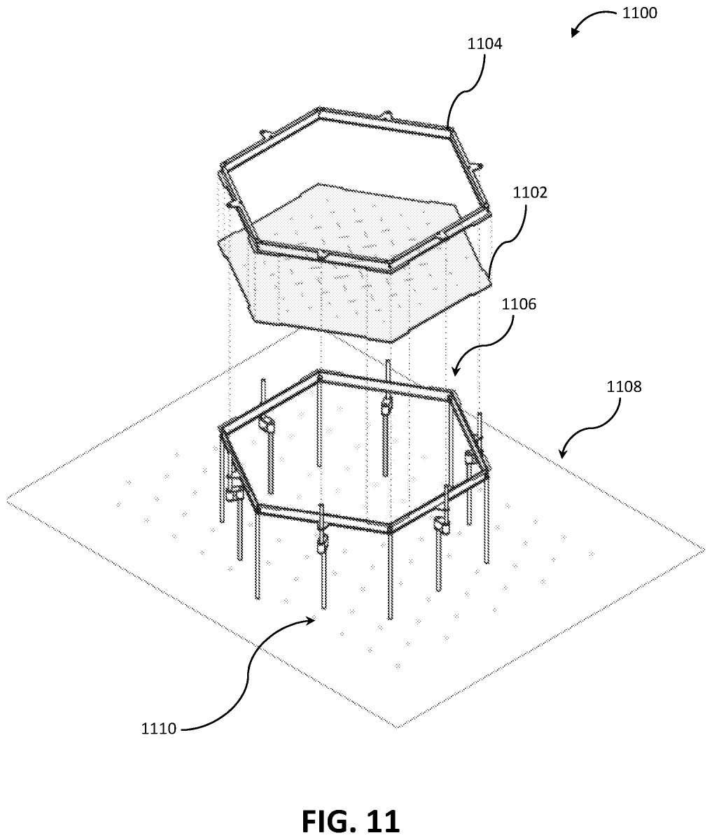

FIG. 11 depicts a support frame 1100 for heating a panel 1102 in accordance with one example. The support frame 1100 may be configured to provide sufficient space for the glass to sag during heating. In this example, the support frame 1100 includes an upper rim 1104 and a lower rim 1106 that engage opposite sides of the panel. The rims 1104, 1106 are configured to engage the panel 1102 along an outer edge thereof. The lower rim 1106 is supported by a plurality of legs of the support frame 1100. In this example, each leg has an integrated clamp to secure the upper and lower rims 1104, 1106 in place. Spring mechanisms may be incorporated into the clamps to provide a desired clamping force to the glass. The configuration, construction, and other characteristics of the support frame 1100 may vary.

The characteristics of the kiln in which the support frame 110 is disposed may also vary. For instance, various types of heat sources may be used.

The temperature sequence may be used to control the extent of slumping or sagging. For instance, increasing the duration of time the glass is at its slumping temperature (i.e., the soak time) results in an increased amount of sag or curvature. The temperature sequence for heating the panels may vary. One example temperatures sequence is set forth below, with the understanding that other temperature levels and time periods may be used.
1. from room temperature, ramp up to 964 F/518 C over 360 minutes
2. ramp up to 1076 F/580 C over 15 minutes
3. hold at 1076 F/580 C 30 minutes
4. ramp down to 964 F/518 C over 15 minutes
5. ramp down to 914 F/490 C over 5 minutes
6. hold at 914 F/490 C 45 minutes
7. ramp down to 764 F/406 C over 30 minutes
8. ramp down to 84 F/29 C over 60 minutes

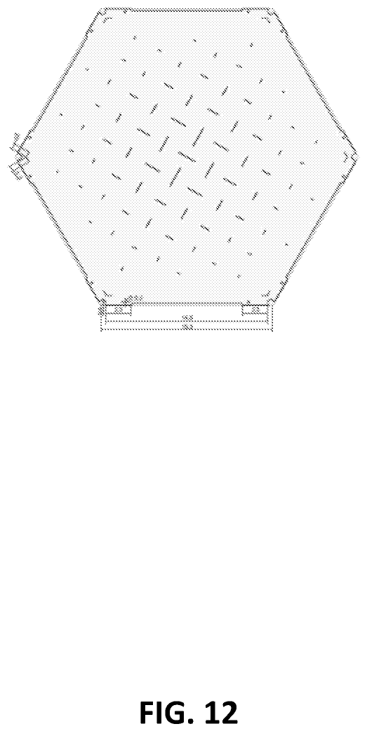

FIG. 12 depicts a flat panel having an edge configured to facilitate engagement by a support frame, such as the support frame 1100 of FIG. 11. In this case, the flat panel includes relief cuts in the corners of the flat panel. The relief cuts may be sized (e.g., sufficiently short or small) such that no acoustic effect is provided thereby. The relief cuts may be configured to accept or otherwise accommodate hardware connectors. Further details regarding an example of the hardware connectors are provided below.

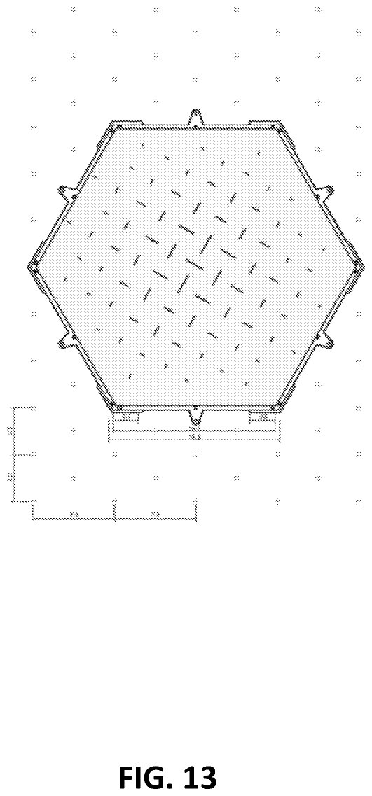

FIG. 13 depicts an example arrangement of temporary support rods for a panel disposed in the support frame. The number, spacing (density), cross-section, and other characteristics of the temporary support rods may vary. The extent to which the support rods are used may also vary. Rods outside of the support frame are depicted for ease in illustration of the spacing and arrangement of the rods.

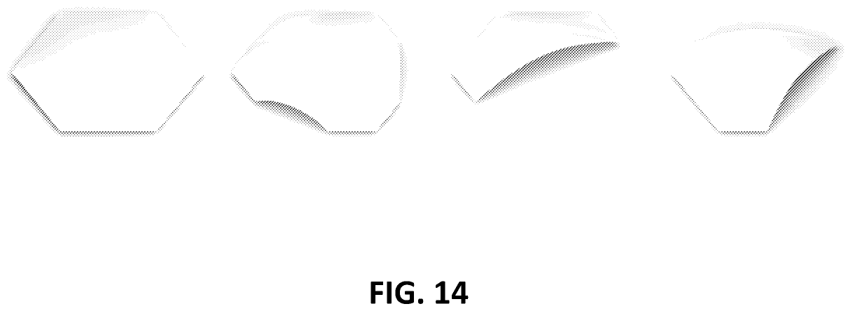

FIG. 14 depicts different acoustic panes with edge condition variations according to several examples. These examples depict how the perimeter or shape of the acoustic devices may vary. Differently shaped devices may be included in an acoustic system to more completely cover a wall or other surface.

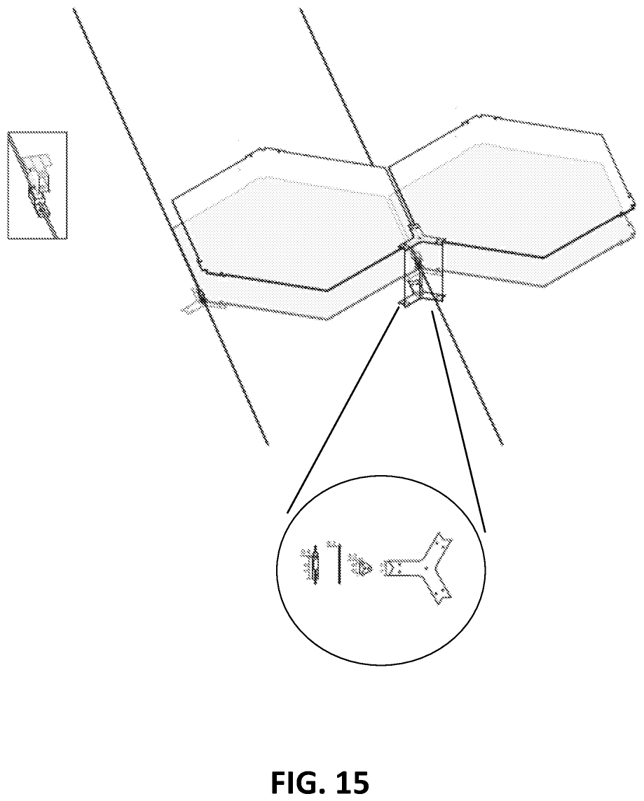

FIG. 15 depicts a suspension system of the disclosed acoustic systems according to one example. The suspension system may include support wires and attachment hardware to assemble the acoustic panes. The hardware components may include various types of clips or other attachment mechanisms. In this example, the attachment hardware includes an adjustable cable gripper, one or more metal plates, and various fastener arrangements (e.g., washers, nuts and bolts). In some cases, the metal plates are placed on the surface of the glass plate and aligned to pre-cut holes and areas of the glass that have been pressed flat in the support frame. Rubber washers hold the metal plates off of the glass to protect the glass from direct contact with the metal. The fasteners secure (e.g., sandwich) the metal plates around the glass. The cable gripper slides along and grips to the tension wire.

The relief cuts along the edges of the panels (e.g., as shown in FIG. 12) may be configured to provide stress relief for the slumps at locations where the movement of the glass while slumping might build up stress due to, for instance, the geometry of the shape or more material being held or pinched by the frame. In such cases, the material may be held at a corner because of the location of the suspension hardware. More material may be left in the locations at or near the hardware to allow for a larger surface area for the metal plate in the hardware and to provide sufficient spacing from the edge of the glass for fasteners, e.g., the bolts. With too little spacing from the edge of the glass, the glass may be fragile where the holes are cut for the bolts. Depending on the geometry of the perimeter, additional or alternative relief cuts may be useful elsewhere to, e.g., otherwise prevent cracking, at tight corners for example, whether or not there is hardware placed there.

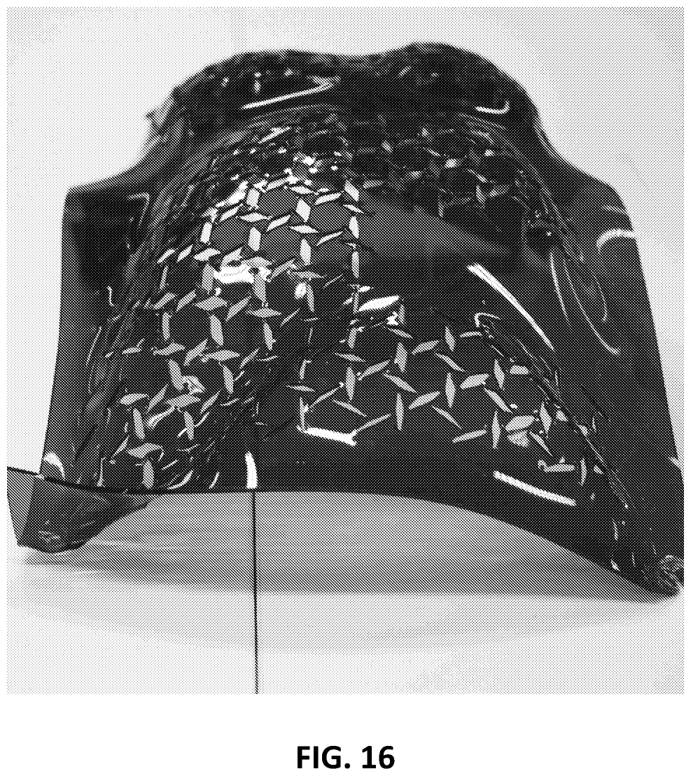

FIG. 16 depicts a panel exhibiting auxetic curvature according to one example. The auxetic curvature is enabled via the cuts formed in the panel. During the slumping, the panel near the cuts unwinds, or twists, in an auxetic manner. Where the cuts are located, the material sags more freely than in regions without cuts, as the glass stretches under its own weight. The ease of movement ends abruptly at the perimeter of the panel, and inflection points are introduced. The panel may thus include double curvatures, such as saddle surfaces.

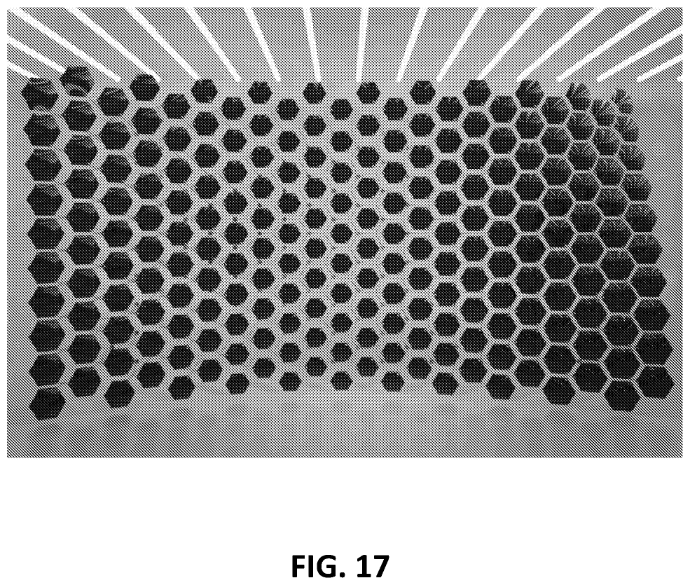

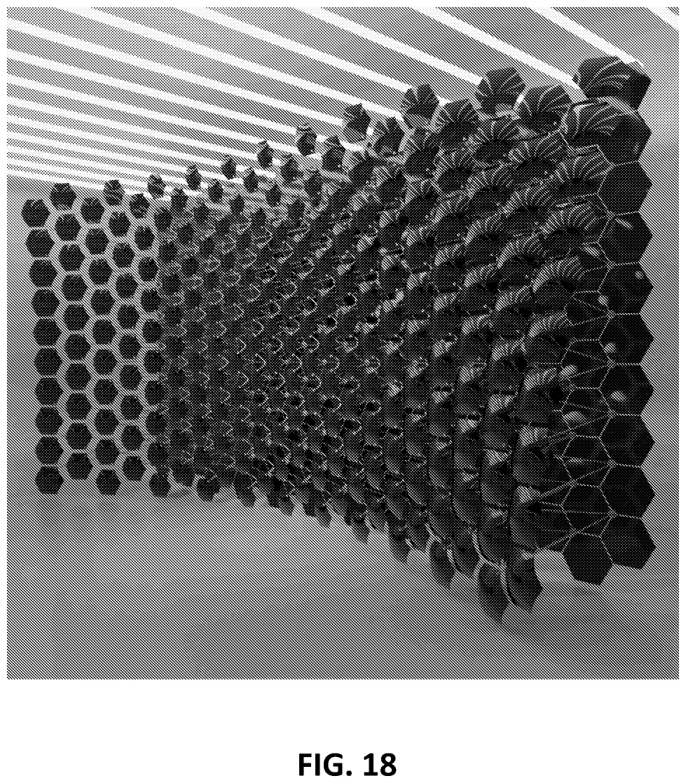

FIGS. 17 and 18 depict examples of acoustic systems including an array of panes. The example of FIG. 17 is a single layer array. The example of FIG. 18 is a two-layer array. Any number of layers may be assembled. In each case, the acoustic system also includes a suspension system that engages and supports the panes. The panes may thus be aggregated along a wall or other surface. The panes may be similarly or variably configured as described herein. In other cases, the panes may stand alone rather than be mounted on a wall or other surface.

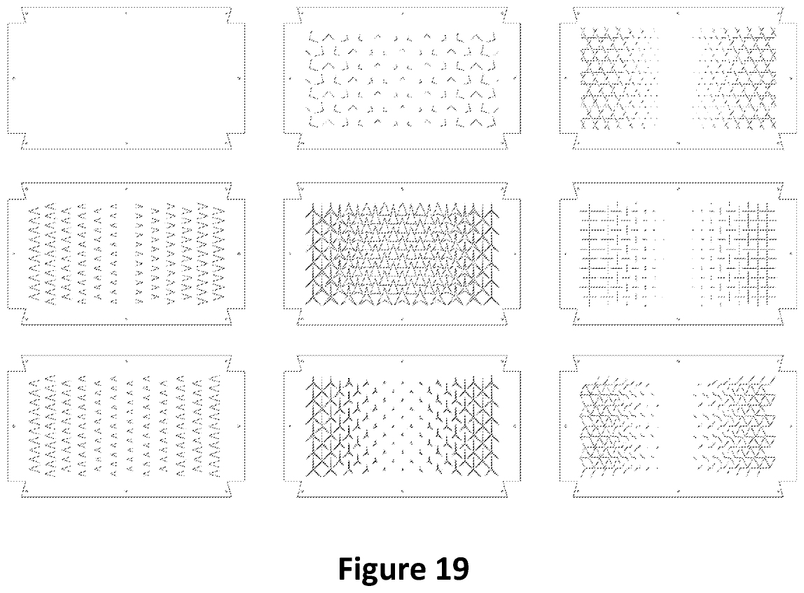

FIG. 19 depicts a number of examples of cut patterns. The examples show how, in some case, the cuts in a respective panel may have different shapes.

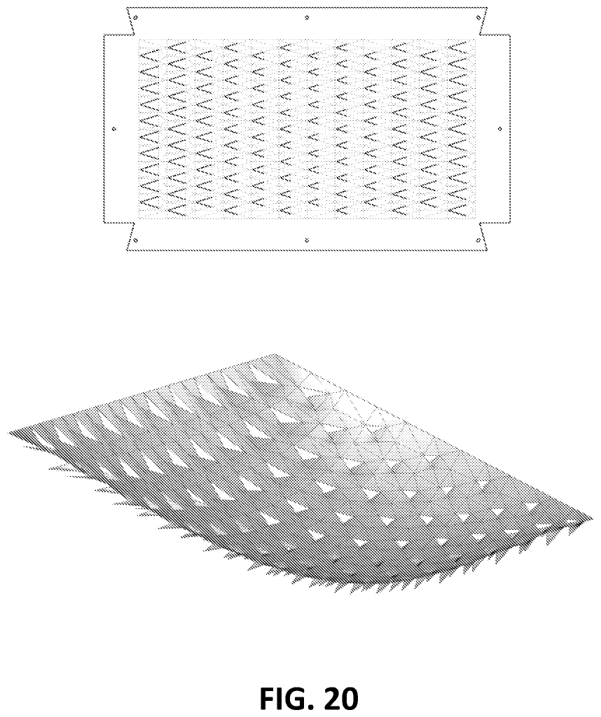

FIG. 20 shows an example of an acoustic pane having non-auxetic deformation. In this example, the acoustic pane includes V-shaped cuts that lead to triangular flaps as a result of sagging. The flaps may provide a directionality to the set of openings.

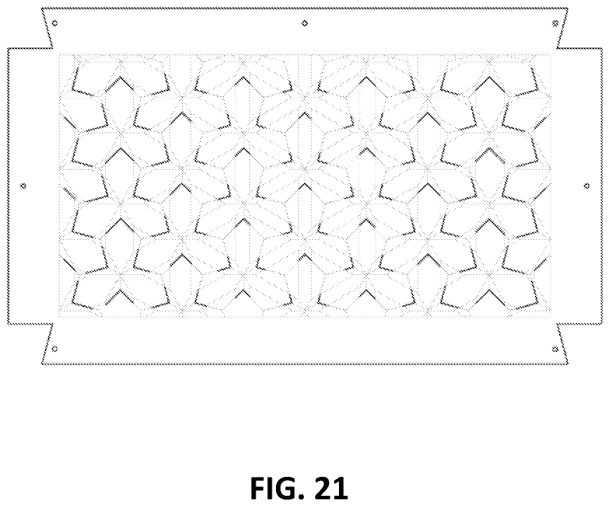

FIG. 21 shows an example of a panel having cuts arranged in a triad pattern. In this case, each cut is V-shaped. Unlike the examples above, the triad pattern orients the V-shaped cuts in different directions. A variety of other orientations and patterns may be used.

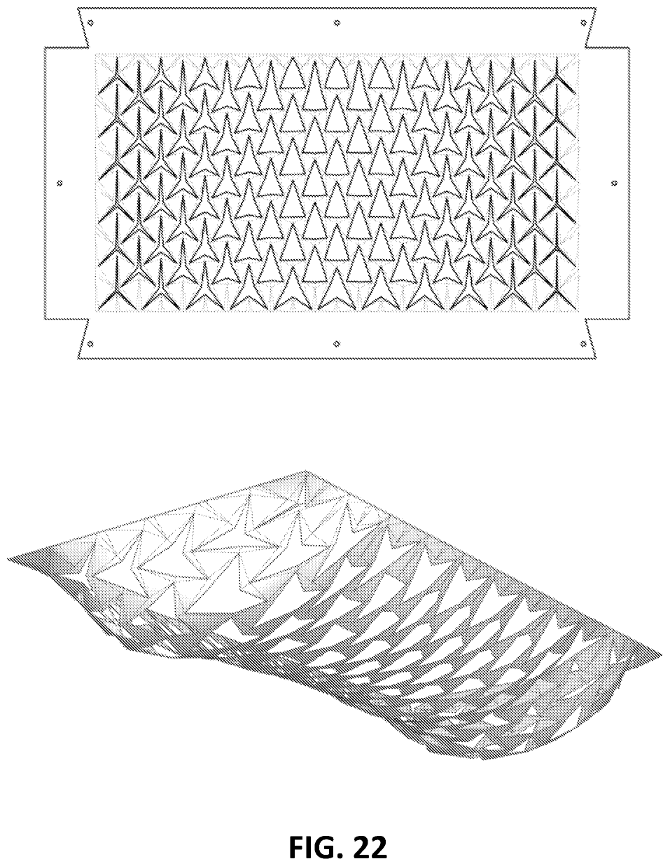

FIG. 22 depicts an example of a panel having holes of varying shapes. In this example, the holes range from slits (e.g., a line cut) to holes (e.g., cuts that remove a shape). In some cases, a Resch pattern is provided. The Resch pattern includes Y-shaped cuts that form triangular faces that rotate when the pane sags. The Y-shaped cuts may create flaps shaped as triangles or hexagons. The variable hole pattern may lead to variable amounts of auxetic behavior, e.g., from fully auxetic to non-auxetic.

FIG. 23 depicts an example of an acoustic system having a number of surfaces covered with panes. In some cases, the acoustic system may be used to cover a number of the surfaces of a room. The aggregation of the panes described herein allows a variety of different surfaces to be covered by the disclosed acoustic devices.

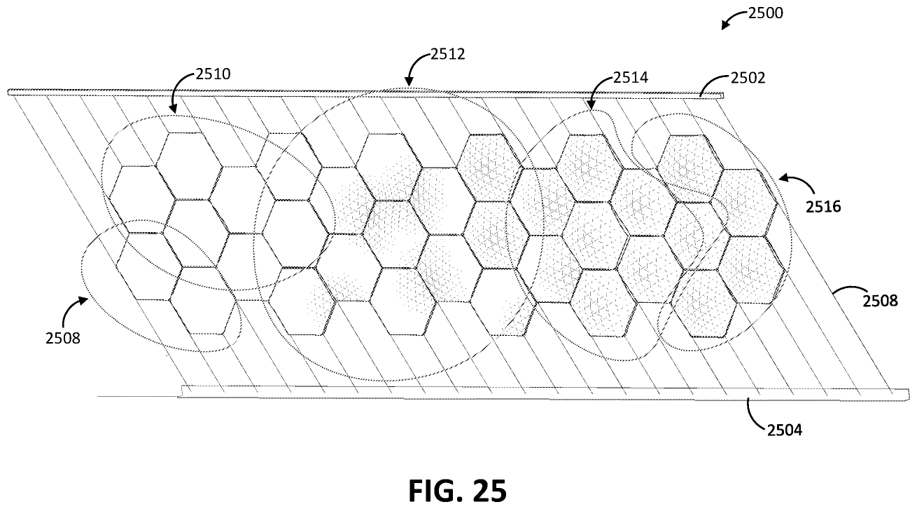

FIG. 25 depicts an example of an acoustic system 2500 having multiple regions or portions configured to implement different acoustic functions. In this example, the acoustic system 2500 is suspended between upper and lower mounting objects 2502, 2504 via a set of guide wires 2506. The acoustic system 2500 may be disposed along a wall of a room and/or in front of a backer or other substrate. In other cases, the acoustic system 2500 is not disposed in a suspended configuration.

Each zone or region of the acoustic system 2500 includes a set of panes. The cut patterns of the panes vary to establish the acoustic function of the zone. For instance, the panes within each zone may have different cut patterns. As described herein, in some cases, the cut pattern varies across an individual pane.

In the example of FIG. 25, the panes are arranged and otherwise configured such that the acoustic system 2500 includes a reflective zone 2508, a focusing zone 2510, a diffusive zone 2512, an absorptive zone 2514, and a transparent zone 2516. Adjacent zones may or may not overlap as shown. Some portions of the acoustic system 2500 may present a mixture or combination of acoustic functions (e.g., diffusive and absorptive). Fewer, additional, or alternative zones may be provided. The arrangement, size, shape, acoustic function, and other characteristics of the zones may vary from the example shown.

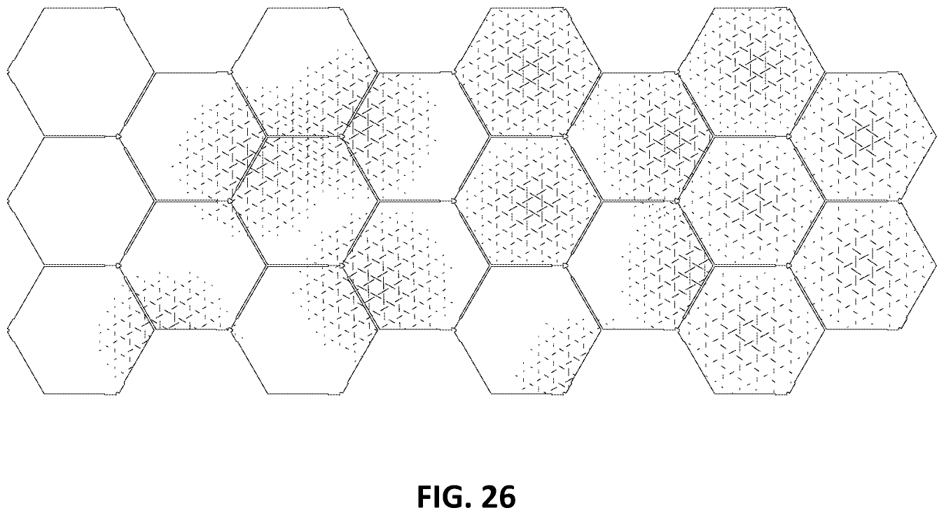

FIG. 26 is a schematic view of an acoustic system having a plurality of panes in accordance with another example. In this case, perforation patterns are shared by adjacent panes of the plurality of panes. As shown in the example of FIG. 26, the perforation patterns, extend across the boundary between the adjacent panes. As a result, multiple panes may contribute to the implementation of a respective acoustic function provided by the acoustic system.

Described below are a number of acoustic systems in which shaped glass panes are arranged and otherwise configured to exhibit a number of acoustic effects and functions. The multiplicity and variety of acoustic effects and functions are achieved despite the glass-based composition of the panes. The acoustic systems described below also provide a number of examples in which a respective portion of the acoustic system is exhibiting multiple acoustic behaviors or functions (e.g., both absorption and diffusion). For instance, the multiple functions may be provided simultaneously for frequencies falling within the audible range (e.g, the frequencies of the human voice).

Glass is a ubiquitous material in the built environment, primarily occurring as visually transparent flat panes, and fibrous systems for thermal and acoustically absorptive performance. The flat panes tend to reflect sound energy and the glass fibers tend to absorb it-seemingly opposing behaviors which have led to the widely-accepted consideration that the two types of glass-based structures are different acoustic materials. While largely semantic in nature, this distinction may be detrimental to the development of new acoustic surfaces and architectural designs. Because glass panes and fibers are made of the same substance, even if different formulations are used, the increasingly dissipative acoustic behavior from one to the other can be, in part, attributed to shape, scale, and configuration.

A wide range of glass shapes between flat sheets and fibrous surfaces is possible. Various shapes appear in the built environment, though they are relatively uncommon and usually invoked as visual design or, increasingly, structural elements. For an overview on interesting recent work utilizing curved glass, see Neugebauer (2014). An example using shaped glass for acoustic performance is Casa da Música in Porto, Portugal, by the Office for Metropolitan Architecture with TNO Eindhoven/DHV as acoustician. The Grand Auditorium within that project used corrugated glass panels as acoustic diffusion (OMA 2022). Other common architectural or structural materials, such as wood, melamine, PET, aluminum, steel, acrylic, concrete, and glass, have been used to construct acoustic panels that reflect, diffuse, absorb, or transmit.

In contrast to such past structures, the disclosed systems may include continuously changing geometry to move fluidly through the range of acoustic behaviors, the assembly of moments on this continuum into an intentional acoustic gradient, and the invocation of visual properties to inform acoustic design decisions. Glass materials may be useful in the construction of such acoustic surfaces due to its visual appeal, relatively low cost, malleability, and integrity at many scales. While glass is usually engaged for its visual transparency, the differences in wavelength between light and sound offer an opportunity for the visual to inform the aural, by allowing the exploration of precise details in service to the much larger wavelengths of sound. The correlation between acoustic dissipation and visual complexity demonstrates a convergence of the aural and visual characteristics of the system. While fabrication techniques and light qualities may make individual panes of the system distinct, the relatively large wavelengths of sound see a more continuous surface as described herein.

The disclosed systems may be fabricated using the kiln-based processes described herein. The fabrication process may control of the shape of a curved panes without the use of a mold, and thereby support a number of features of the acoustic system, as described herein. Additional or alternative processes may be used, including, for instance, mold-based processes. However, molds that can withstand elevated temperatures for glass forming are expensive and time consuming to produce, often contributing dramatically to material usage and waste. The panes of the disclosed systems may instead be created using a kiln frame that was operated during a kiln cycle to allow freeform sagging of the pane, examples of which are described herein.

In some cases, a double layered kiln frame may be used. For example, rods, suspending the frame above the bed of the kiln, support the lower layer. The blanks (e.g., hexagonal blanks) rest on the lower layer of the frame and are held in place with temporary support rods from below. The upper layer of the frame is lowered to pinch the glass during the kiln cycle. This double layer system may use a spring mechanism that is operated outside of the heated spaces of the kiln to apply a clamping force to the glass. The result is a clean edge that has been clamped mid-slump to allow for initial movement in the glass during the cycle ramp up and a controlled perimeter condition. One useful aspect of this approach is that it avoids the necessity of modifying the glass pane after the slump cycle through any glass coldworking processes.

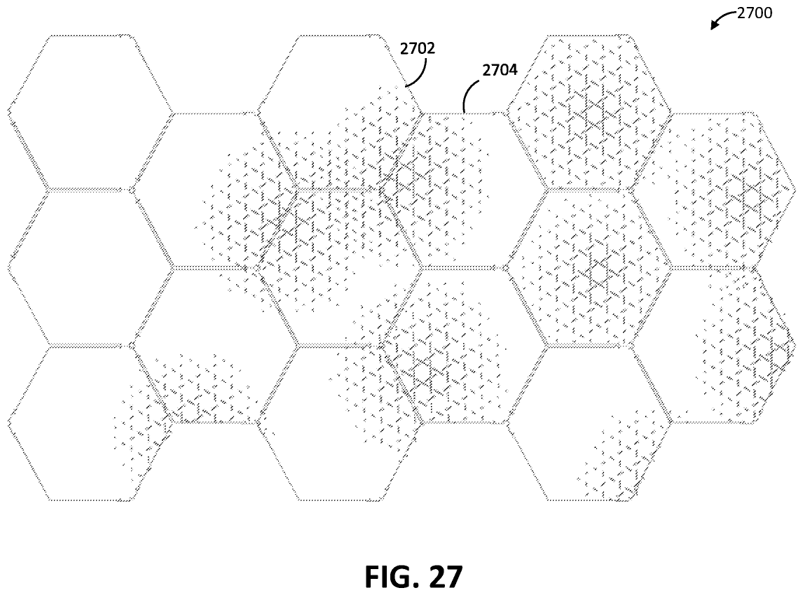

The plurality of panes and/or other aspects of the disclosed systems provide the ability to shift variables within the production of each pane to control a range of output geometries, functions, and/or behaviors. Each pane may have the same initial shape (e.g., hexagonal shape) configured to act as an acoustically-reflective blank. The pane size may be configured to reflect most of the wavelength range of the human voice, and to accommodate the connection details of the base of a kiln. Then, varying shifts in form (or shape) are introduced, and correlate with a variance in how the pane interacts with sound waves. As described herein, the blank can be modified by the presence, quantity, spacing, and locations of linear slits in auxetic patterns; and the ramp-up rate of and duration at slump temperature. These two properties allow the panel to sag to a controlled degree, with the simultaneous opening of perforations determined by the initial slit pattern and placement. As also described herein, auxetic patterns increase the rate and severity of slumping versus regions without auxetic patterns, adding a variable of control that can give rise to asymmetric geometries and allow for geometric continuity between adjacent panels (see, e.g., FIG. 27)

The cutting and forming process creates a glass pane with specifically controlled curvature and openings, which are determinative of acoustic behavior and effects. For example, flat areas of the surface will reflect sound, while curved areas will diffuse sound. Internal spatial volumes accessible by sound can be created by pairing two panes if at least one pane has openings. Such a pairing creates an opportunity for absorption via Helmholtz resonance, the mechanism of which works based on the air defined by cavities and the openings that lead to them. If substantial perforations are present in both panes, sound can pass entirely through the surface and transmission can be achieved.

In the disclosed systems, the individual acoustic behavior of each pane is pursued in the context of the aggregate panel collection. The disclosed systems may thus not be viewed or considered as an array of distinct panels, but rather as a single glass surface or a single acoustic surface. The auxetic patterns are utilized to control the quantity and size of openings as well as the severity of the slump depth achievable within the kiln cycle.

As described above, the auxetic patterns demonstrate a negative Poisson's ratio. When stretched, the auxetic pattern expands in the axis perpendicular to the stretching force. Auxetic patterns cut into slumped glass may induce inflection points, vary the size of openings, and coordinate curvature with modifications to the pattern. Auxetic cut lines allow the surface of the glass to move more freely during the slumping process. This freedom of movement transforms the slits of the cuts into larger openings as the glass material unwinds in the x and y-axes of the original pane as the surface alters in the z-direction during slumping. The perforations cut into the blanks of the disclosed systems may or may not give rise, or lead, to auxetic behavior. A modified auxetic pattern may thus be provided in which a pane exhibits a mixture of auxetic and non-auxetic behavior, e.g., in which one or more of the openings in the pane give rise, or lead, to auxetic behavior, and one or more of the openings do not give rise, or lead, to auxetic behavior. The length of the slit or other opening may be used to control whether the respective opening leads to auxetic behavior. In some examples, the length of the slits may gradually decrease or increase along a particular dimension. At some point along the dimension, the openings transition from or to openings that lead to auxetic behavior.

In some of the examples described below, the length of the cut lines within the auxetic pattern gradually decrease as the pattern moves away from the centroid of the pane (e.g., the centroid of the hexagon). As the cut lines become shorter, the ability of the surface to unwind is reduced, and smaller holes are created. This gradual restraint of the auxetic pattern controls the opening sizes to maintain a necessary balance between the amount of surface area that is closed versus open in the defined volume. Such control may be useful, for instance, in obtaining Helmholtz resonance-one (e.g., primary) sound absorption mechanism exhibited by the disclosed systems (e.g., for particular frequencies).

In other cases, the pattern of the cut lines may be shifted from the centroid of the pane. By shifting or biasing the pattern to one side (or in one direction), the overall form of the slump is affected. For instance, instead of the sagging the most at the centroid, the peak of the slump may be shifted toward one side or other portion of the pane. As shown in the example of FIG. 27, a system 2700 includes a plurality of panes are configured such that the placement of the cut lines (or pattern) is also coordinated between adjoining panes 2702, 2704 of glass in consideration of aggregate surface continuity. The location of the perforations cut into one blank (or pane) may thus be determined in relationship to neighboring panes. This allows for areas of concentrated opening, or acoustic behaviors that are exhibited across multiple panes.

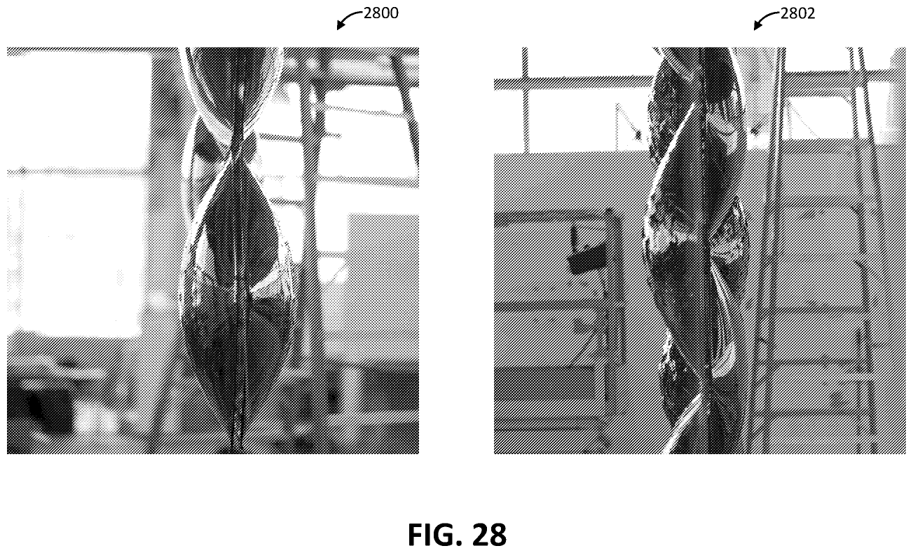

As shown in FIG. 28, the panes of the disclosed systems may be disposed in multiple-layer arrangements. FIG. 28 depicts example systems 2800, 2802 in which panes are disposed in two layers back-to-back (or face-to-face). In some cases (e.g., the system 2800), once slumped, each pane is paired face-to-face along the edges with another pane to make a glass bubble, a two-pane pairing. The characteristics of each pair is determined by several parameters or features including, for instance, the overall volume of air contained between the two pieces of glass, the sidedness of perforations or lack of perforations across the glass bubble (both panes perforated, one or the other, neither pane), concavity, convexity, or flatness of both or either side, continuity of perforation across the pattern as it relates to neighboring panes of glass, and the relationship of surface curvature to neighboring panes of glass. The combination of these parameters defines the geometric qualities of each individual bubble and its resulting contribution to the overall acoustic behavior of the system (or portion or zone thereof).

FIG. 28 depicts two examples of pane pairing. In the system 2800, the panes of a pairing are aligned with one another. In the system 2802, the panes in the two layers are offset (e.g., laterally offset) from one another.

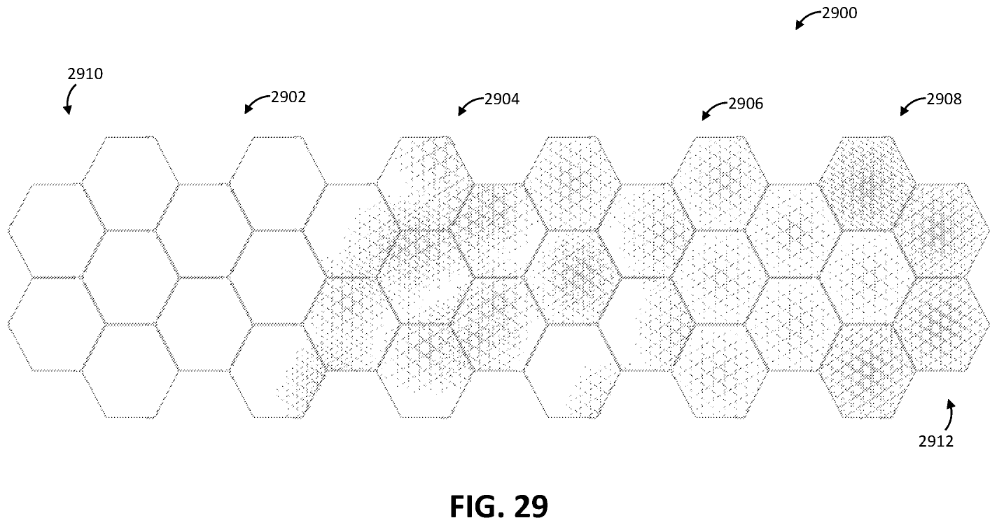

FIG. 29 depicts a two-layer system 2900 in accordance with one example. In this case, the panes in the two layers are aligned such that a series of glass bubbles are established across an extent (e.g., length) of the system. As a result, a continuous gradient of acoustic behaviors is exhibited. In this example, moving across the extent of the system (e.g., wall), the dominant acoustic behaviors shift from reflective (see, e.g., area 2902 where the majority of the exposed panes were flat or nearly flat, and with zero holes), to diffusive (see, e.g., area 2904 where slumps and perforations disperse the soundwaves), to absorptive (see, e.g., area 2906 where sounds waves are converted to heat inside of perforated bubbles), to transparent (see, e.g., area 2908 where both panes of a glass bubble are severely slumped and perforated). The severity of each acoustic behavior depends not only on individual panel geometry, but also on relationships to surrounding panels.

The system 2900 shown in FIG. 29 provides an example of how varying configuration of panes across the plurality of panes is used to establish a monotonic gradient in an acoustic function (e.g., absorption) across the extent of the acoustic surface. In other examples, a monotonic gradient may be exhibited in an alternative or additional acoustic function, such as diffusion. As described herein, the variance in the pane configuration includes the degree of curvature and the number of holes. As also described herein, additional configuration parameters may be varied across the panes, including the locations of the holes, the alignment of the holes between the two layers, and the hole patterns (e.g., whether holes are present in one or both layers).

The gradient acoustic surfaces of the disclosed systems may be used to exhibit acoustic behavior that spans across any combination of the behaviors of reflection, diffusion, absorption, and transmission.

The elevational view of FIG. 29 depicts the hole patterns for the two layers via differences in greyscale or color. The holes in the panes of the front layer are shown in darker (blue), while the holes in the panes of the back layer are lighter (orange).

The surface area of each glass panel generally increases as slumping progresses under the influence of gravity. The auxetic pattern reduces stretching by allowing the surface to spin and open; what begins as a small slit created during the water jet cutting process becomes a wider opening as the surfaces around it are free to pull away from one another. In acoustics, surface area is often used to describe the area of the footprint of a surface, not taking into account the detailed surface shaping. However, the term “surface area” is used herein to take into account the total surface area exposed to sound, including scales that represent the surface shaping, perforation boundaries, edges, and the surfaces of the interior volume. In the example system 2900 shown in FIG. 29, the surface area generally increases from an end 2910 to an end 2912, as the severity of panel deformations increases.

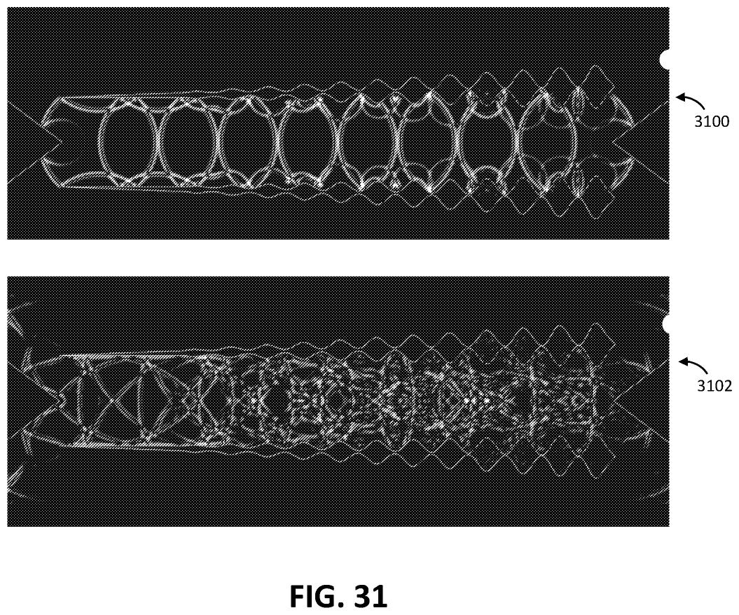

FIG. 31 depicts a sequence of simulation images representative of sound energy during interaction with an acoustic system in accordance with one example. The sound energy is interacting with one or more two-dimensional acoustic surfaces, such as a corridor. In the examples shown, the surfaces progress from flat to diffusive, to cavities which exhibit a trapping of sound energy. The simulations may be representative of room acoustics. While simulations in room acoustics usually utilize geometrical ray tracing for the prediction of statistical room acoustics parameters, such as reverberation time, a wave-based method known as finite-difference time domain (FDTD) was used in two dimensions to inform decisions about surface shaping. For instance, the technique was used to study the severity of slumping, the ability of sound to access cavities via openings, and the aggregate behavior of panels.

The examples shown in FIG. 31 are simulation stills of sound in a two-dimensional corridor made of rigid boundaries. An image 3100 is taken from an early timestep, and an image 3102 is the same sound energy at a later timestep. From left to right, the energy is coherent, then dispersed, then reduced, indicating continuity between acoustic reflection, diffusion, and absorption.

The disclosed systems are capable of a useful technique for achieving acoustic absorption in architecture. Acoustic absorption in architecture is usually achieved with porous absorption (e.g., surfaces of fibers or pores) that disrupt the organized movement of air molecules in sound waves, converting the energy to heat. Any material (substance) that can take such a finely-scaled form with ample depth and coverage will exhibit absorptive behavior. While porous absorption is effective, the depth required can be prohibitive for the relatively large wavelengths of middle to low frequency sound, and visually transparent materials such as glass take on distinct visual opacity in fibrous form. Alternative absorption mechanisms include panel resonance and Helmholtz resonance, the latter of which may be used by the disclosed systems. In Helmholtz resonance, a cavity of air, openings to that cavity, and throat length (opening thickness) determine a frequency of resonance, at which a narrow band of absorption is exhibited. The air cavity, openings, and throat combination are a system that resonates at a particular frequency, meaning sound waves at that frequency pump violently across the opening, leading to conversion of energy to heat. In the case of Helmholtz resonance, the result is absorption centered at the resonant frequency, along with a narrow band surrounding the resonant frequency.

Across the extent of the example of FIG. 29, e.g., from the end 2910 to the other end 2912, the increasing severity of slumping and the opening of the auxetic pattern slits are configured to progress into Helmholtz resonance range for frequencies associated with the human voice. In other words, moving along the length the collective acoustic surface, the flat reflective surfaces give way to diffusion, which then give way to absorption as the two layers of glass and their openings emerge in the right combinations. The example system 2900 of FIG. 29 thus establishes that absorption may be achieved as a part of the continuous change of form and the gradients of acoustic behavior. The example system 2900 primarily puts the absorption into the audible range, in particular the frequencies of the human voice, but, in other examples, other frequencies may be targeted. The example system 2900 also shows that cavity and opening combinations can be configured such that a range of frequencies can be spanned.

The disclosed systems also provide examples of how the categories of acoustic reflection, diffusion, absorption, and transmission can be considered parts of a continuous spectrum of dissipation, and that high surface area systems tend to dissipate sound more than low surface area surfaces. However, the distinct categorization of acoustic surfaces as reflective, diffusive, absorptive, and transmissive remains a well-established and useful perspective. Sound energy incident on a surface can be thought of as being split between these categories in proportions that depend on the acoustic nature of the surface. For example, a traditionally-absorptive surface would absorb most incident energy, but may also reflect, diffuse, and transmit small fractions of it.

As described herein, the disclosed systems may exhibit a continuous spectrum or monotonic gradient of dissipation and/or another (e.g., more specific) acoustic function, such as reflection, diffusion, absorption, and transmission. Still other acoustic functions may be exhibited, including, for instance, focusing.

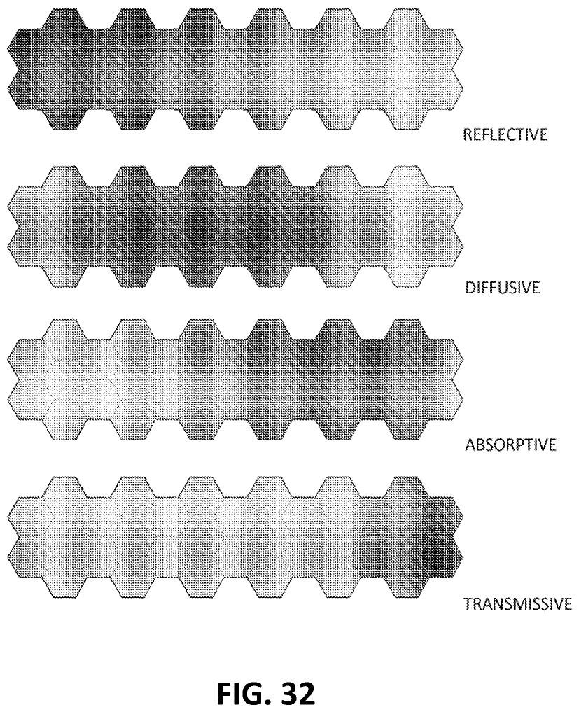

FIG. 32 schematically depicts the primary or dominant acoustic functions of the example of FIG. 31. The dominant acoustic behavior in a given area or zone or portion of the system is established via one or more parameters or characteristics of the panes in the portion. For instance, the flat surfaces in one zone reflect sound in a specular way, the shaped surfaces in another zone diffuse sound (relative to the flat panes), and the highly-open and perforated surfaces in yet another zone transmit sound.

As shown via shading in FIG. 32, the acoustic behaviors across the system are gradients and concentrations within different zones of the surface (e.g., wall). The severity and direction of slumps, as well as location and quantity of perforations determine the degree to which the surface behaves within each of these behaviors. The example of FIG. 32 also shows how acoustic absorption is occurring, and that the absorption increases, i.e., progresses in severity, along the extent of the system.

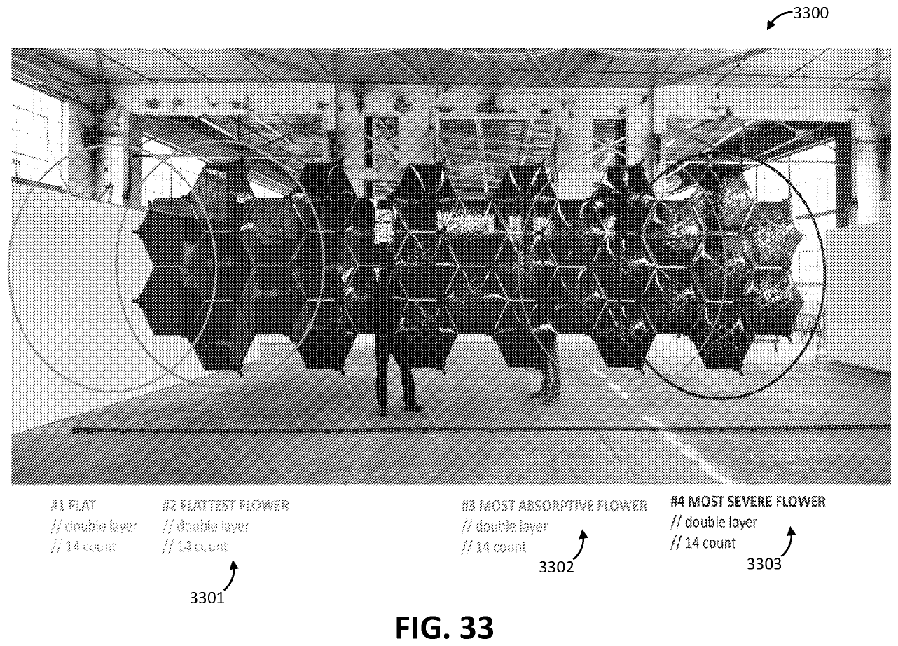

FIG. 33 depicts an example system 3300 that was subjected to a series of absorption testing. In this example, three sections 3301-3303 of the system 3300, each a set of seven glass bubbles, were tested separately, along with a benchmark condition of flat panels. The sections are labeled in FIG. 33 as particular “flowers”.

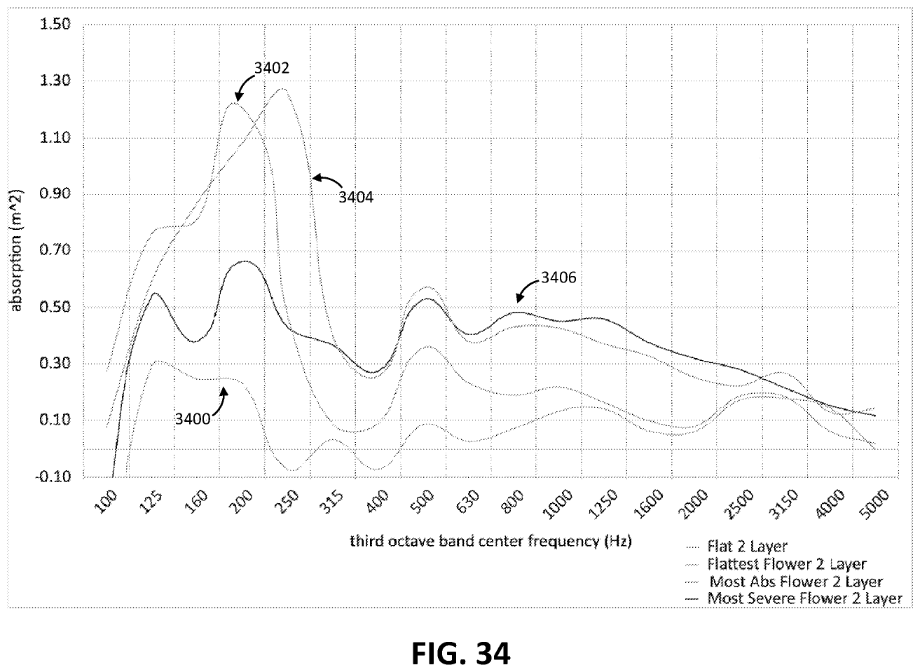

As shown in the graphical plot of FIG. 34, each of the sections 3301-3303 exhibited measurable absorption, including the flat benchmark and the most mildly dissipative flower. Above 400 Hz, absorption increased at nearly all frequencies from section to section moving along the extent of the disclosed system. Below 400 Hz, absorption due to Helmholtz resonance dominated, as shown in the peaks of the lighter (orange) and darker (blue) curves. While the acoustic properties of reflection, diffusion, and transmission are readily apparent in the properties and behavior of this example, the testing verified the presence of absorption, if even in small quantities, as well as the increase in the severity of absorption along the length of the surface.

In FIG. 34, the results of the standardized absorption tests are presented as m² of absorption on the vertical axis, and third-octave band center frequency on the horizontal axis. Curve 3400 represents the flat baseline. Curve 3402 corresponds with the mild-shaped section of the surface. Curve 3404 corresponds with the middle section. Curve 3406 corresponds with the most severely shaped section.

The disclosed systems may be useful in a wide variety of applications calling for a degree of absorption (e.g., controlled or limited absorption rather than maximum absorption per unit area), including those, for instance, involving overlapping acoustic behaviors, such as the wall of a concert hall, or other installations involving implementation at room scale.

The examples described herein utilize the malleability of sheet glass to obtain both curvature and opening. These and other aspects, such as spatial coordination in double panes or layers for the incorporation of airspaces, may be used in architectural and other contexts to realize a range of acoustic behaviors. Systems may be configured to exhibit particular types of acoustic behaviors, or gradients that span between them.

The disclosed systems apply glass as an acoustic material, while embedding performance intrinsically into the surface itself. Optical attributes and spatial division are also taken on within the disclosed systems. In this manner the forms and details of a glass structure go beyond the often-limited view of glass within an architectural space as being either a flat pane window punctured into a wall system or an acoustical treatment, such as fiberglass. Instead, the disclosed systems show that glass can be the entire architectural spatial system, and that this thinking can be applied to other material types capable of taking on a range of forms, shapes, and scales.

The presence of, and monotonic gradient (e.g., increase) in, absorption across the surface of the disclosed systems is useful. The amount of absorption achieved may be tuned and leveraged in various ways. The fact that absorption can be accessed through change in form after passing through the properties of reflection and diffusion, and on the way to transmission, establishes that glass and other materials are intrinsically acoustic. Glass and other transparent materials may be useful in architectural applications where transparency is desired visually and acoustic performance is useful. For acoustic spaces such as those where music performance and recording are important, the surfaces can be tuned to the specific preferences of rooms. In some cases, the transparent material may form an entire enclosure where the modified glass panels fully encompass the occupants of the room.

The hexagonal shape of each glass pane in the examples described above may be useful in creating a large acoustic surface. Hexagonal tiling configures adjacency for each element with six other components in a system that can expand in multiple directions. As a result, surface and perforation continuity may be established between neighboring panes. With hexagonal panes, three self-similar forms share a common vertex, providing a logical pattern for consideration of attachment points within the system. Each hexagonal pane, if held at three points, can be attached to all six adjacent panes, and extension of the surfaces vertically and horizontally is facilitated. Hardware and tension cables may be capable of suspending the glass bubbles from inside of the glass forms. This feature allows glass to be the dominant material of the surface exposed to sound energy from outside of the forms. This feature also allows for maximum visual transparency and lightness to the system. Notwithstanding the foregoing features, alternative or additional module shapes may be used, with corresponding modifications to the surface transformation across the edge and sag curvatures, as well as the behavior of the unwinding of the auxetic pattern.

Tinted or colored glass may be used to provide a visual register for physical details such as alignment, overlap, and imperfections during the making process. This included the subtle contrast between a cut and uncut surface and a difference in color tone between a single layer and double-layered system. Once assembled, reflections of the surroundings on the surface of the tinted glass allow for a strong visual register of relative curvature or flatness as demonstrated through visual distortion. Lighter or transparent glass, e.g., float panes and other glass materials that are created to be optically clear, may be used. However, tinted glass and its relevant surface modifications may provide a visual register of the system, allowing the glass to be seen instead of seen through. Striking visual attributes occur at various scales, including optical effects evident when a piece of glass that was flat is otherwise surrounded by curved forms, distortions of curvature between concavity and convexity, and the compounding effects of perforations as seen through multiple layers.

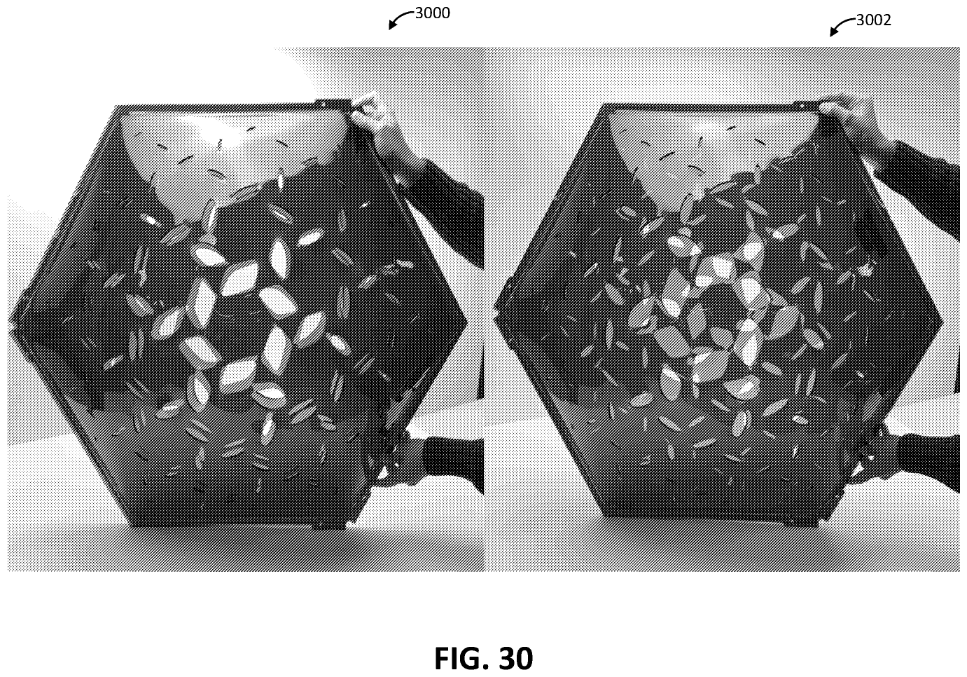

FIG. 30 depicts examples of glass pane pairs 3000, 3002 with holes that are aligned and non-aligned. In the glass pane pair 3000, the holes are aligned. In the glass pane pair 3002, the holes are non-aligned. The tinting of the glass panes allows the hole alignment or non-alignment to be visually detected. So, while the color of the glass has no bearing on the acoustic performance of the system, the optical attributes of the panes may provide a mechanism to visually guide or understand the geometrical variations within the system that do matter to sound. Connecting the details and shaping of the glass to how the surface interacts with sound energy leads to a correlation in the visual reading of the system or other variations of glass formation with a surface's potential acoustic behaviors.

Additional variables, such as glass formulation and thickness, may also be varied. Thickness decreases minutely with increasing slump severity. However, in some cases, all of the panels have identical mass because all start with a blank of the same material, shape, and dimensions, though small quantities of mass may be lost (e.g., to the initial line work cut during the water jetting process). In processes utilizing cut lines (e.g., instead of cut out holes), the quantity of surface area removed in the cutting process may be very limited.

Although described in connection with wall systems, the disclosed systems may be deployed in a wide variety of contexts, locations, and applications. The disclosed systems are thus not limited to positions along a wall or other architectural or other structure. The disclosed systems are also not limited to planar or upright arrangements or configurations. For instance, the panes of the disclosed systems may be disposed in a wide variety of orientations. The panes of the disclosed systems may also be oriented differently from one another.

Although described herein in connection with examples involving float glass, the disclosed systems may use additional or alternative types of glass materials. For instance, the panes of the disclosed systems may be composed of, or otherwise include, other types of solid glass. Each pane may thus have a uniform composition and/or one-piece construction. A wide variety of non-fibrous or other non-composite glass-based materials and structures may be used. Also, although described in connection with examples involving hexagonal panes, a wide variety of shapes may be used, as described above.

Described above are examples of acoustic systems having an acoustic surface with 64 hexagonal, slumped glass panes, arranged in two layers of 32 panels each. The surface exhibits a gradient in one or more acoustic functions including, for instance, reflection, diffusion, absorption, and transmission. The gradients are achieved via modification of the form of glass panes at a variety of scales. Moving from flat panels at one end to increasingly slumped and perforated forms and culminating in deeply curved panels with porous openings, the components of the disclosed systems aggregate into an acoustic and visual system of versatile behavior. The flat end primarily exhibits acoustic reflection, the center diffusion, and the severe end absorption and transmission, though all parts of the surface exhibit all four behaviors to some extent. The disclosed systems may be fabricated using the controlled slumping of glass through cut auxetic patterns and/or other techniques. The acoustic performance of the disclosed systems demonstrated a correlation between the complexity of form, the presence of openings, and the severity of acoustic absorption.

The functionality of any of the examples described herein may be frequency dependent. For instance, one or more zones of an acoustic system may provide one acoustic function in a first frequency range, and another acoustic function in a second frequency range. The disclosed devices and systems may thus be configured to provide one or more acoustic responses that vary(ies) as a function of frequency.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. An acoustic system comprising:
a framework; and
a plurality of panes supported by the framework and arranged to form an acoustic surface;
wherein:
each pane of the plurality of panes comprises a face with a respective degree of curvature, the face having a respective number of holes, the number being zero or more;
the degree of curvature and the number of holes differ across the plurality of panes to establish a monotonic gradient in an acoustic function across an extent of the acoustic surface.

2. The acoustic system of claim 1, wherein the acoustic function is dissipation.

3. The acoustic system of claim 1, wherein the acoustic function is absorption.

4. The acoustic system of claim 1, wherein the acoustic function is reflection.

5. The acoustic system of claim 1, wherein the acoustic function is transmission.

6. The acoustic system of claim 1, wherein the acoustic function is diffusion.

7. The acoustic system of claim 1, wherein:
the acoustic surface has a first end and a second end; and
the monotonic gradient extends from the first end to the second end.

8. The acoustic system of claim 1, wherein:
the degree of curvature and the number of holes of the plurality of panes establishes a plurality of zones of the acoustic surface;
the panes in each zone of the plurality of zones collectively establish a primary acoustic function for the zone; and
the primary acoustic functions differ across the plurality of zones.

9. The acoustic system of claim 8, wherein the panes in each zone of the plurality of zones are configured such that an acoustic response of each zone comprises further acoustic functions at a lower level than the primary acoustic function.

10. The acoustic system of claim 8, wherein:
the primary acoustic function of a first zone of the plurality of zones is reflection;
the primary acoustic function of a second zone of the plurality of zones is diffusion; and
the primary acoustic function of a third zone of the plurality of zones is absorption.

11. The acoustic system of claim 10, wherein the first, second, and third zones are disposed in a sequential arrangement across the extent of the acoustic surface in accordance with the monotonic gradient.

12. The acoustic system of claim 8, wherein:
the plurality of zones comprise a fourth zone in which transmission is the primary acoustic function; and
the fourth zone is adjacent the third zone.

13. The acoustic system of claim 8, wherein the panes in the first zone are flat and have zero holes.

14. The acoustic system of claim 1, wherein the curvature of the faces of the panes increases along the gradient.

15. The acoustic system of claim 1, wherein the number of holes in the faces of the panes increases along the gradient.

16. The acoustic system of claim 1, wherein the holes in the face of each pane of the plurality of panes have respective sizes that decrease as distance from a centroid of the pane increases.
